(19) United States
(12) Patent Application Publication
(10) Pub. No.: US 2007/0149281 A1
(43) Pub. Date: Jun. 28, 2007

(54) VIRTUAL MOVABLE MECHANICAL DISPLAY DEVICE

(75) Inventors: Chris Gadda, Las Vegas, NV (US); Randy Hedrick, Reno, NV (US); Harold E. Mattice, Gardnerville, NV (US)

Correspondence Address: BEYER WEAVER LLP, P.O. BOX 70250, OAKLAND, CA, 94612-0250, US

(73) Assignee: IGT, Reno, NV (US)

(21) Appl. No.: 11/683,296

(22) Filed: Mar. 7, 2007

Related U.S. Application Data
(63) Continuation-in-part of application No. 11/557,876, filed on Nov. 8, 2006.
(63) Continuation-in-part of application No. 11/218,688, filed on Sep. 2, 2005.

(51) Int. Cl. G06F 19/00

(52) U.S. Cl. 463/34

(57) ABSTRACT

Various techniques are disclosed for displaying content on a movable display device. According to specific embodiments, content to be projected onto a first surface portion of the movable display device may be identified. At least one operation may be performed to determine movement characteristics associated with the movable display device during a first time period when the movable display device is moving. At least one operation may be performed to coordinate a first portion of the content to be projected with movement of the movable display device in a manner such that, when the first portion of content is projected onto the movable display device, the projected content is coordinated with movement of the movable display device. The first portion of content may then be projected onto the first surface portion of the movable display device during the first time period.

### RELATED APPLICATION DATA

This application is a continuation-in-part of prior U.S. patent application Ser. No. 11/557,876 (Attorney Docket No. IGT1P338/P-1125) entitled “SIMULATION OF MECHANICAL REELS OF GAMING MACHINES” by Hedrick et al., filed on Nov. 8, 2006, from which priority is claimed pursuant to the provisions of 35 U.S.C. 120, and which is incorporated herein by reference in its entirety and for all purposes.

This application is a continuation-in-part of prior U.S. patent application Ser. No. 11/218,688 (Attorney Docket No. IGT1P182/P-1008) entitled “VIDEO AND MECHANICAL SPINNING BONUS WHEEL” by Mattice et al., filed on Aug. 2, 2005, from which priority is claimed pursuant to the provisions of 35 U.S.C. 120, and which is incorporated herein by reference in its entirety and for all purposes.

### BACKGROUND OF THE INVENTION

1. Technical Field

The present invention relates generally to gaming machines and systems, and more specifically gaming machine display systems and devices.

2. Background

Casino gaming machines are well known in the art. Such devices may be embodied as spinning reel slot machines, video slot machines, Video Poker machines or the like. These machines are played by a player making a wager and prompting play. A computer processor for the device selects and displays an outcome. For a slot machine, the processor randomly selects and displays symbols which combination or combinations define one or more winning outcomes. The player receives an award for each winning outcome and loses their wager for losing outcomes.

It has become popular to provide, for gaming devices such as slot machines, one or more bonus game features. As is known in the art, the player makes their wager and plays a base game obtaining winning and losing outcomes. When a trigger condition is obtained, the bonus feature is enabled. The bonus feature may entail the display of bonus outcome selections where the player makes a selection to reveal a bonus.

Typically, a conventional gaming machine can have various audio and visual display components. Apparatuses and methods for providing displays in gaming machines and/or within a casino are generally well known, and instances of such apparatuses and methods can be found in, for example, U.S. Pat. Nos. 6,135,884; 6,251,014; and 6,503,147, each of which is incorporated herein by reference in its entirety and for all purposes. Such video displays can be used to simulate mechanical gaming reels, whereby all elements of the displayed wheels are controlled and displayed electronically. Alternatively, physical gaming reels may be displayed behind a main display glass or other like viewing element, with the rotation and positioning of these physically present gaming reels being determined and controlled electronically, as is known in the art.

Various methods of gaining and maintaining interest in game play include designing and providing gaming machines with intriguing and different themes, game types, artwork, visual displays, sounds and the like. One attractive feature for many players is the use of a mechanical rotating bonus wheel or a virtual animated bonus wheel in a gaming machine, particularly where the bonus wheel is integrated with game play and/or other pertinent presentations to a game player and instances of such apparatuses and methods can be found in, for example, in U.S. Pat. Nos. 5,788,573, 6,224,483 or in the Wheel of Fortune® Gaming Machines. The bonus wheel tends to be relatively dramatic and attracts players due to the excitement of playing the bonus round. Unfortunately, these types of mechanized wheel-based games can often be inflexible and cannot be reconfigured once the physical values are placed on the mechanized wheel. In order to reconfigure the wheel or the value on the wheels, a technician would have to take the gaming machine apart. This would create downtime for the gaming machine and the gaming machine would not generate any profit during this downtime.

### SUMMARY OF THE INVENTION

Various aspects of the present invention are directed to different methods, systems, and computer program products for displaying content on a movable display device. According to specific embodiments, content to be projected onto a first surface portion of the movable display device may be identified. At least one operation may be performed to determine movement characteristics associated with the movable display device during a first time period when the movable display device is moving. At least one operation may be performed to coordinate a first portion of the content to be projected with movement of the movable display device in a manner such that, when the first portion of content is projected onto the movable display device, the projected content is coordinated with movement of the movable display device. The first portion of content may then be projected onto the first surface portion of the movable display device during the first time period. In at least one embodiment, at least a portion of the content projected by the projection system onto the first surface portion of the movable display device is dynamically generated. In some embodiments, the first portion of the projected content may be synchronized with the movement of the movable display device such that the first portion of projected content is continuously projected at a fixed relative location on the first surface portion while the movable display device is moving. In at least some embodiments, rotational movement of the movable display device may be detected and/or monitored during the first time period, and content projected onto the first surface portion of the movable display device may be coordinated with the rotation of the movable display device in a manner which creates a visual appearance of a rotating mechanical display device having at least one symbol, character and/or object affixed thereto. According to various embodiments, content projected onto the first surface portion of the movable display device may be coordinated with the rotation of the movable display device in a manner which creates a visual appearance of a rotating mechanical wheel or rotating mechanical sphere.

Other aspects of the present invention are directed to a casino gaming machine comprising at least one processor; at least one interface operable to provide a communication link to at least one other device; memory; a movable display device including a first surface portion; and a projection system operable to project content onto the first surface portion of the movable display device. In at least one embodiment, the gaming machine may be operable to project content onto the first surface portion of the movable display device during a first time period when the movable display device is moving. Additionally, the gaming machine may be operable to manage content projected onto the first surface portion of the movable display device such that the projected content is coordinated with movement of the movable display device during the first time period.

Other aspects of the present invention are directed to a movable display system comprising at least one processor; at least one interface operable to provide a communication link to at least one other device; memory; a movable display device including a first surface portion; a projection system operable to project content onto a first surface portion of the movable display device; and a content generation engine operable to dynamically generate at least a portion of the content projected by the projection system onto the first surface portion of the movable display device. In at least one embodiment, the movable display system may be operable to project content onto the first surface portion of the movable display device during a first time period when the movable display device is moving. Additionally, In at least one embodiment, the movable display system may be operable to coordinate projection of content onto the first surface portion of the movable display device with movement of the movable display device during the first time period.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIGS. 1A and 1B show perspective views of various gaming machine embodiments.

FIGS. 2A and 2B show simplified block diagrams of various gaming machine embodiments.

FIGS. 3-15 show examples of different embodiments of movable virtual mechanical display systems.

FIG. 16A depicts an example embodiment of various gaming machine components which may be used for implementing various features described herein.

FIG. 16B shows an example of a projection display device in accordance with a specific embodiment.

FIGS. 17A and 17B show examples of specific embodiments of movable virtual sphere-shaped mechanical display system.

FIG. 18 is a block diagram of an example of a gaming network in accordance with a specific embodiment.

FIG. 19 shows a flow diagram of a Mechanical Display Virtualization Procedure 1900 in accordance with a specific embodiment

FIG. 20 shows a flow diagram of a Bonus Game Virtual Mechanical Display Procedure 2000 in accordance with a specific embodiment

FIG. 21 shows an example embodiment of a movable virtual mechanical display system which includes multiple projection sources.

### DETAILED DESCRIPTION OF EXAMPLE EMBODIMENTS

Example embodiments will now be described in further detail, and accompanied by the drawings. In the following description, numerous specific details are set forth in order to provide a thorough understanding of example embodiments. It will be apparent, however, to one skilled in the art, that example embodiments may be practiced without some or all of these specific details. In other instances, well known process steps and/or structures have not been described in detail in order to not obscure example embodiments.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

As noted above, various aspects of the present application relate to improved gaming machine display systems and display devices.

For example, one aspect relates to the use of electro-luminescent displays in gaming systems. Typically, electro-luminescent displays are to overcome at least some of limitations of conventional mechanical slot machine display devices. However, electro-luminescent displays typically do not provide the look and feel of the analogous mechanical components (e.g., reels, wheels, globes, and/or other movable mechanical displays, collectively referred to herein as “movable displays”) which are preferred by the players of traditional mechanical slot machines. Hence, it would be useful to provide a gaming machine with dynamically configurable movable displays that can also provide the look and feel of traditional mechanical movable displays. Furthermore, alternative techniques that do not use luminescent displays may also be desirable.

Accordingly, several embodiments described herein relate to various techniques for simulating or virtualizing mechanical movable displays. The techniques are especially suitable for simulating the “look and feel” of mechanical reels and/or bonus wheels typically used for games and/or bonus games which are played at conventional gaming machines.

It will be appreciate that mechanical movable displays can be simulated using a variety techniques including projection-based techniques and non-projection based techniques. The non-projection based techniques may include, for example, displaying images on flat, bent, curved and/or flexible displays using, for example, Liquid Crystal Displays (LCD), Light Emitting Diode (LED) displays, Organic Light Emitting Diode (OLED) displays. Typically, projection-based techniques (e.g., Digital Light Processing) use a projector or projection engine to project images on flat, bent, curved and/or flexible surface. In any case, images can be displayed and/or projected on a stationary or a moving (e.g., rotating) display and/or projection surface. Examples of different projection techniques are discussed in more detail below. Those skilled in the art will appreciate that similar techniques can be used to display images on displays (e.g., LCD).

In accordance with one aspect of the invention, image(s) of at least one rotating mechanical wheel is projected on at least one projection surface to effectively simulate the appearance of a rotating mechanical wheel which includes static content imprinted thereon and/or affixed thereto. The image can be projected on different types of rotating projection surfaces, as described in greater detail below. In one embodiment, projection can be accomplished by using a projection system coupled to one or more processors that processes projection data. Projection data can be downloaded and/or stored on a gaming machine. The projection data can effectively represent images, objects and/or symbols to be projected on one or more projection surfaces.

According to specific embodiments, projection of the images/objects may be synchronized with the rotation (and/or other movement) of projection surface in order, for example, to enable a projected object to remain at a fixed relative location on the projection surface as the projection surface is moved (e.g., rotated). In addition to a projector (e.g., a DLP projector), the projection system can include one or more lenses and/or mirrors. Further, a rotation mechanism (e.g., stepper motor, DC motor) may be utilized to externally drive (or rotate) a projection surface without interfering with the projection system.

Example Gaming Machine Embodiments

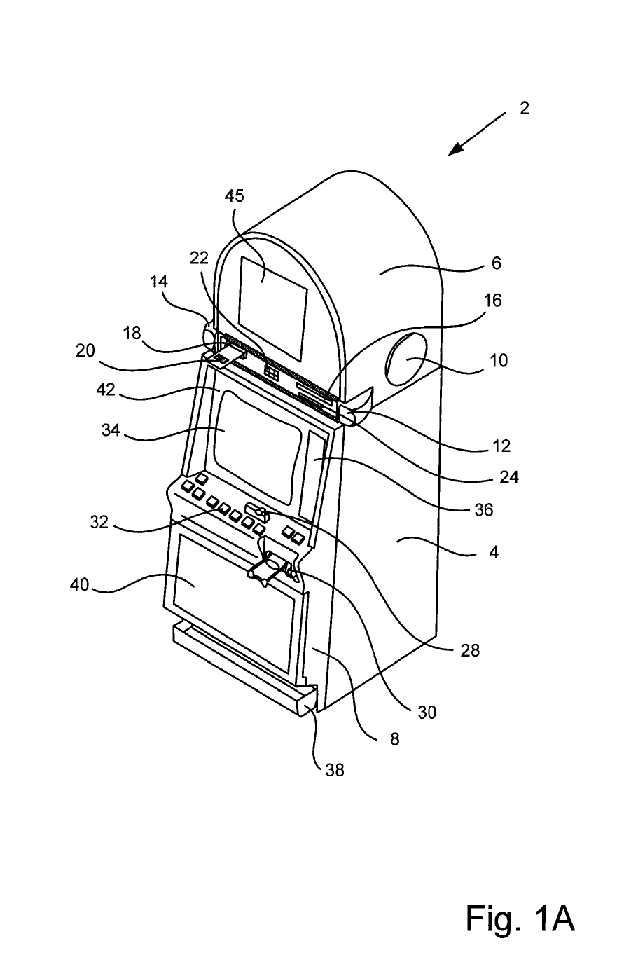

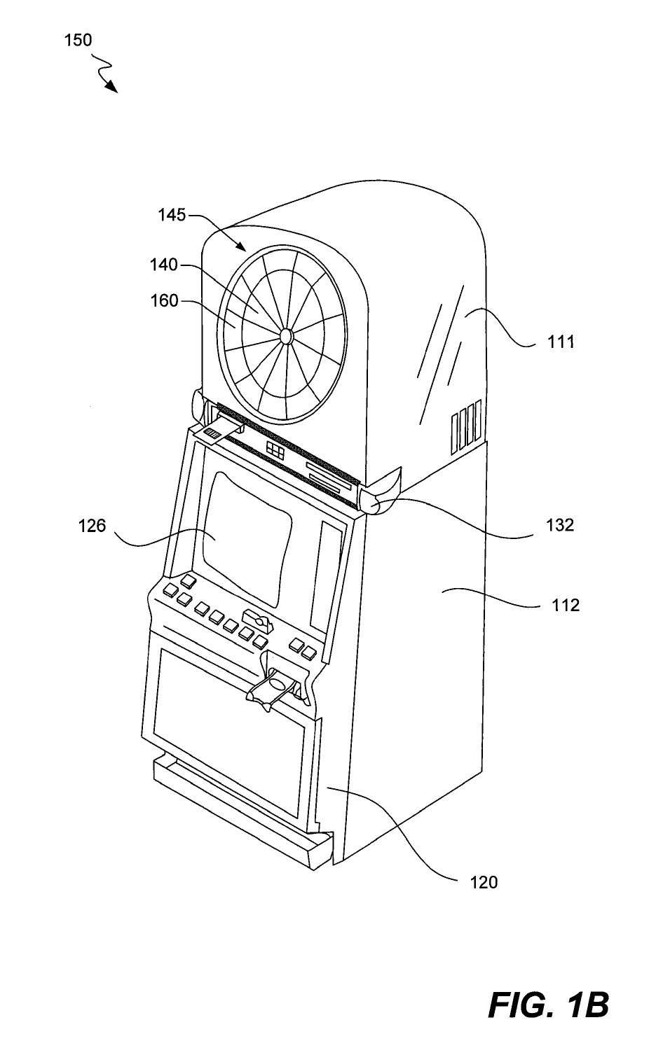

FIG. 1A shows a perspective view of an exemplary gaming machine 2 in accordance with a specific example of an embodiment. As illustrated in the example of FIG. 1A, machine 2 includes a main cabinet 4, which generally surrounds the machine interior (illustrated, for example, in FIG. 2B) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a belly glass 40. Viewable through the main door is a video display monitor 34 and an information panel 36. The display monitor 34 will typically be a cathode ray tube, high resolution flat-panel LCD, or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. According to a specific embodiment, the devices may be controlled by code executed by a master gaming controller housed inside the main cabinet 4 of the machine 2. In specific embodiments where it may be required that the code be periodically configured and/or authenticated in a secure manner, example embodiments may be used for accomplishing such tasks.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

As illustrated in the example of FIG. 1A, the gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display device 45. In at least one embodiment, display device 45 may be configured as a movable display, for example, capable of linear and/or rotational movement. The ticket printer 18 may be used to print tickets for a cashless ticketing system. Further, the top box 6 may house different or additional devices not illustrated in FIG. 1A. For example, the top box may include a bonus wheel or a back-lit silk screened panel which may be used to add bonus features to the game being played on the gaming machine. As another example, the top box may include a display for a progressive jackpot offered on the gaming machine. During a game, these devices are controlled and powered, in part, by circuitry (e.g. a master gaming controller) housed within the main cabinet 4 of the machine 2.

It will be appreciated that gaming machine 2 is but one example from a wide range of gaming machine designs relating to example embodiments. For example, not all suitable gaming machines have top boxes or player tracking features. Further, some gaming machines have only a single game display—mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that example embodiments, as described below, can be deployed on most any gaming machine now available or hereafter developed.

Some preferred gaming machines of the present assignee are implemented with special features and/or additional circuitry that differentiates them from general-purpose computers (e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed to be state-based systems. In a state-based system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award is indicated. As anyone who has used a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

For example, a watchdog timer is normally used in International Game Technology (IGT) gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

IGT gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modern general-purpose computers include voltage monitoring circuitry, these types of circuits only report voltage status to the operating software. Out of tolerance voltages can cause software malfunction, creating a potential uncontrolled condition in the gaming computer. Gaming machines of the present assignee typically have power supplies with tighter voltage margins than that required by the operating circuitry. In addition, the voltage monitoring circuitry implemented in IGT gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for IGT slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc that occurred just prior to the malfunction. After the state of the gaming machine is restored during the play of a game of chance, game play may resume and the game may be completed in a manner that is no different than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion. Further details of a state based gaming system, recovery from malfunctions and game history are described in U.S. Pat. No. 6,804,763, titled “High Performance Battery Backed RAM Interface”, U.S. Pat. No. 6,863,608, titled “Frame Capture of Actual Game Play,” U.S. application Ser. No. 10/243,104, titled, “Dynamic NV-RAM,” and U.S. application Ser. No. 10/758,828, titled, “Frame Capture of Actual Game Play,” each of which is incorporated by reference and for all purposes.

Another feature of gaming machines, such as IGT gaming computers, is that they often include unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include EIA 485, EIA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, IGT's Netplex is a proprietary communication protocol used for serial communication between gaming devices. As another example, SAS is a communication protocol used to transmit information, such as metering information, from a gaming machine to a remote device. Often SAS is used in conjunction with a player tracking system.

IGT gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device addresses. General-purpose computer serial ports are not able to do this.

Security monitoring circuits detect intrusion into an IGT gaming machine by monitoring security switches attached to access doors in the slot machine cabinet. Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices and/or trusted memory sources are preferably included in an IGT gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms included in the trusted device, the gaming machine is allowed to verify the authenticity of additional code and data that may be located in the gaming computer assembly, such as code and data stored on hard disk drives. A few details related to trusted memory devices that may be used in example embodiments are described in U.S. Pat. No. 6,685,567, filed Aug. 8, 2001 and titled “Process Verification,” and U.S. patent application Ser. No. 11/221,314, titled “Data Pattern Verification in a Gaming Machine Environment,” filed Sep. 6, 2005, each of which is incorporated herein by reference in its entirety and for all purposes.

In at least one embodiment, at least a portion of the trusted memory devices/sources may correspond to memory which cannot easily be altered (e.g., “unalterable memory”) such as, for example, EPROMS, PROMS, Bios, Extended Bios, and/or other memory sources which are able to be configured, verified, and/or authenticated (e.g., for authenticity) in a secure and controlled manner.

According to a specific implementation, when a trusted information source is in communication with a remote device via a network, the remote device may employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 2003/0203756, by Jackson, filed on Apr. 25, 2002 and entitled, “Authentication in a Secure Computerized Gaming System”, which is incorporated herein in its entirety and for all purposes.

Gaming devices storing trusted information may utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Additional details relating to trusted memory devices/sources are described in U.S. patent application Ser. No. 11/078,966, entitled “SECURED VIRTUAL NETWORK IN A GAMING ENVIRONMENT”, naming Nguyen et al. as inventors, filed on Mar. 10, 2005, herein incorporated in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, IGT gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present. Details using a mass storage device that may be used with example embodiments are described, for example, in U.S. Pat. No. 6,149,522, herein incorporated by reference in its entirety for all purposes.

Returning to the example of FIG. 1A, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display device 45 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights behind the belly glass 40. After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

FIG. 1B shows a perspective view of an alternate embodiment of a gaming machine 150. As shown in the example of FIG. 1B, gaming machine 150 also includes a top box 111 and a main cabinet 112, one or both of which can comprise an exterior housing arranged to contain a number of internal gaming machine components. Many features can also be the same or similar to corresponding features in gaming machine 2 (FIG. 1A), such as a main door 120, a primary video display monitor 126 and one or more speakers 132.

As illustrated in the embodiment of FIG. 1B, top box 111 includes a movable display device 145 generally having the appearance of a rotatable mechanical wheel. In one embodiment, the display device 145 may include independently movable portions (e.g., 140, 160). For example, in one embodiment, the display portion 160 has the ability to rotate around display portion 140. As illustrated in the embodiment of FIG. 1B, the movable display device 145 may be operable to rotate around an axis that is substantially horizontal with respect to an ordinary upright position of the gaming machine 150. The direction of rotation may include clockwise, counter-clockwise or combinations thereof.

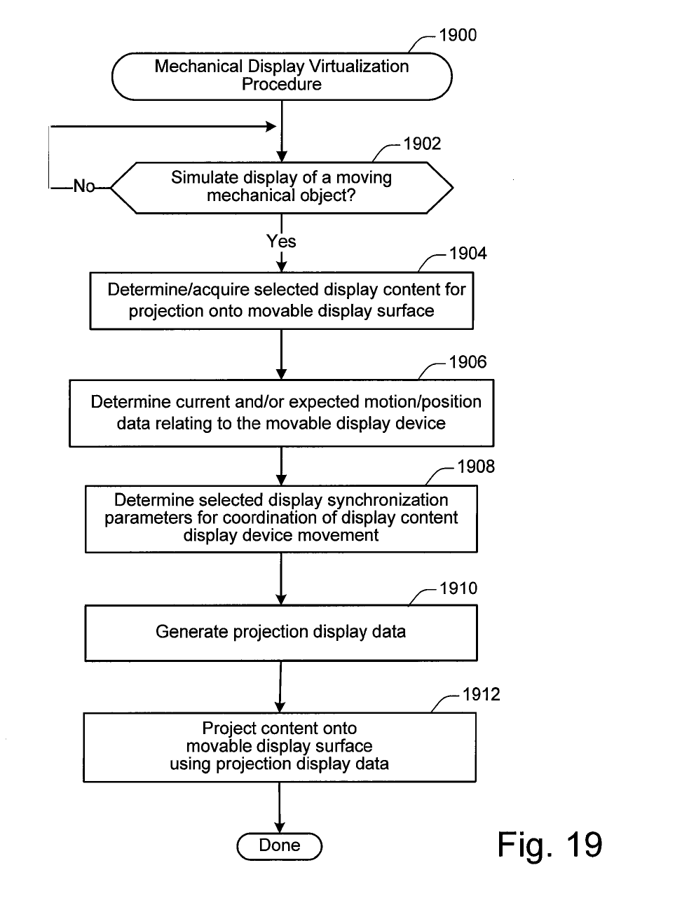

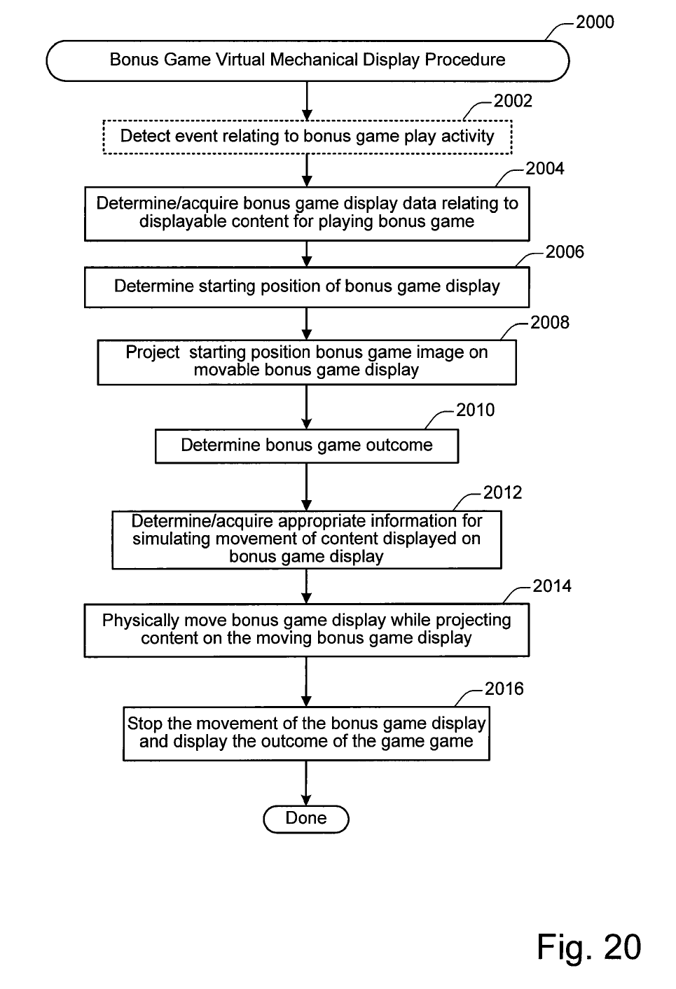

In an alternate embodiment (such as that shown, for example, in FIGS. 19A, 19B, 20B), the movable display device may generally have the appearance of a globe or sphere. In at least one embodiment, the spherical-appearing movable display device may be operable to rotate around an axis that is substantially horizontal with respect to an ordinary upright position of the gaming machine. In at least one other embodiment, the spherical-appearing movable display device may be operable to rotate around an axis that is substantially vertical with respect to an ordinary upright position of the gaming machine. In other embodiments, the axis of rotation may vary, depending upon desired criteria.

For example, an angle of the axis of rotation 150 relative to a front viewing surface of the gaming machine may be varied. For instance, when mounted in a top box, the axis 150 may be tilted down to change a viewing angle of the rotatable object relative to a player playing at the gaming machine 10.

Top box 111 may also comprise a bonus indicator or light, which can be used to indicate whenever the gaming machine enters a bonus mode. Accordingly, it will be readily appreciated that this indicator can be a light, a series of lights, an arrow or other pointer, and/or any other convenient bonus indicator.

As shown in the particular embodiment illustrated, top box 111 may include various components to facilitate the play of a bonus game associated with a main game played on gaming machine 150. In one embodiment, an outcome or series of outcomes on a main game or games played on gaming machine 150 can result in the ability of a player to play in a bonus game on the top box 111 of the gaming machine. Other ways of accessing such a bonus game might also be possible, as desired by a given gaming operator. In one embodiment, the play of the bonus game involves a virtual rotation of images on the inner video display and a physical rotation of the rotatable object.

FIG. 2A is a simplified block diagram of an exemplary gaming machine 200 in accordance with a specific embodiment. As illustrated in the embodiment of FIG. 2A, gaming machine 200 includes at least one processor 210, at least one interface 206, and memory 216.

In one implementation, processor 210 and master game controller 212 are included in a logic device 213 enclosed in a logic device housing. The processor 210 may include any conventional processor or logic device configured to execute software allowing various configuration and reconfiguration tasks such as, for example: a) communicating with a remote source via communication interface 206, such as a server that stores authentication information or games; b) converting signals read by an interface to a format corresponding to that used by software or memory in the gaming machine; c) accessing memory to configure or reconfigure game parameters in the memory according to indicia read from the device; d) communicating with interfaces, various peripheral devices 222 and/or I/O devices; e) operating peripheral devices 222 such as, for example, card readers, paper ticket readers, etc.; f) operating various I/O devices such as, for example, displays 235, input devices 230; etc. For instance, the processor 210 may send messages including game play information to the displays 235 to inform players of cards dealt, wagering information, and/or other desired information.

The gaming machine 200 also includes memory 216 which may include, for example, volatile memory (e.g., RAM 209), non-volatile memory 219 (e.g., disk memory, FLASH memory, EPROMs, etc.), unalterable memory (e.g., EPROMs 208), etc. The memory may be configured or designed to store, for example: 1) configuration software 214 such as all the parameters and settings for a game playable on the gaming machine; 2) associations 218 between configuration indicia read from a device with one or more parameters and settings; 3) communication protocols allowing the processor 210 to communicate with peripheral devices 222 and I/O devices; 4) a secondary memory storage device 215 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming machine to communicate with local and non-local devices using such protocols; etc. In one implementation, the master game controller 212 communicates using a serial communication protocol. A few examples of serial communication protocols that may be used to communicate with the master game controller include but are not limited to USB, RS-232 and Netplex (a proprietary protocol developed by IGT, Reno, Nev.).

A plurality of device drivers 242 may be stored in memory 216. Example of different types of device drivers may include device drivers for gaming machine components, device drivers for peripheral components 222, etc. Typically, the device drivers 242 utilize a communication protocol of some type that enables communication with a particular physical device. The device driver abstracts the hardware implementation of a device. For example, a device drive may be written for each type of card reader that may be potentially connected to the gaming machine. Examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 216 by the processor 210 to allow communication with the device. For instance, one type of card reader in gaming machine 200 may be replaced with a second type of card reader where device drivers for both card readers are stored in the memory 216.

In some embodiments, the software units stored in the memory 216 may be upgraded as needed. For instance, when the memory 216 is a hard drive, new games, game options, various new parameters, new settings for existing parameters, new settings for new parameters, device drivers, and new communication protocols may be uploaded to the memory from the master game controller 212 or from some other external device. As another example, when the memory 216 includes a CD/DVD drive including a CD/DVD designed or configured to store game options, parameters, and settings, the software stored in the memory may be upgraded by replacing a first CD/DVD with a second CD/DVD. In yet another example, when the memory 216 uses one or more flash memory 219 or EPROM 208 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming machine 200 may also include various authentication and/or validation components 244 which may be used for authenticating/validating specified gaming machine components such as, for example, hardware components, software components, firmware components, information stored in the gaming machine memory 216, etc. Examples of various authentication and/or validation components are described in U.S. Pat. No. 6,620,047, entitled, “ELECTRONIC GAMING APPARATUS HAVING AUTHENTICATION DATA SETS,” incorporated herein by reference in its entirety for all purposes.

In specific embodiments where the gaming machine includes a “bonus” game, gaming machine 200 may also include a bonus controller 261 for controlling aspects relating to the bonus game.

As illustrated in the embodiment of FIG. 2A, the gaming machine 200 also includes a movable display controller 250 which may be configured or designed to control various aspects relating to movable displays 262 such as, for example: images, text, and/or other content displayed on one or more of the movable displays; motion control of the movable displays; etc. In at least one implementation, the movable display controller 250 may perform specific operations in response to instructions or signals received from a master gaming controller 212 and/or bonus controller 261. In alternate embodiments, the content and/or movement of the movable displays 262 may be directly controlled by the master gaming controller 212, bonus controller 261, a remote server, an external device, or any combination thereof.

Peripheral devices 222 may also include several device interfaces such as, for example: transponders 254, wire/wireless power distribution components 258, input device(s) 230, sensors 260, audio and/or video devices (e.g., cameras, speakers, etc.), transponders 254, wireless communication components 256, wireless power components 258, etc.

Sensors 260 may include, for example, optical sensors, pressure sensors, RF sensors, Infrared sensors, image sensors, thermal sensors, biometric sensors, etc. Such sensors may be used for a variety of functions such as, for example detecting the presence and/or identity of various persons (e.g., players, casino employees, etc.), devices (e.g., mobile devices), and/or systems within a predetermined proximity to the gaming machine. In one implementation, at least a portion of the sensors 260 and/or input devices 230 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming machine player displays and/or mobile device displays may include input functionality for allowing players to provide desired information (e.g., game play instructions and/or other input) to the gaming machine, game table and/or other gaming system components using the touch keys and/or other player control sensors/buttons. Additionally, such input functionality may also be used for allowing players to provide input to other devices in the casino gaming network (such as, for example, player tracking systems, side wagering systems, etc.)

Wireless communication components 256 may include one or more communication interfaces having different architectures and utilizing a variety of protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

Power distribution components 258 may include, for example, components or devices which are operable for providing wired or wireless power to other devices. For example, in one implementation, the power distribution components 258 may include a magnetic induction system which is adapted to provide wireless power to one or more mobile devices near the gaming machine. In one implementation, a mobile device docking region may be provided which includes a power distribution component that is able to recharge a mobile device without requiring metal-to-metal contact.

In other embodiments (not shown) other peripheral devices include: player tracking devices, card readers, bill validator/paper ticket readers, etc. Such devices may each comprise resources for handling and processing configuration indicia such as a microcontroller that converts voltage levels for one or more scanning devices to signals provided to processor 210. In one embodiment, application software for interfacing with peripheral devices 222 may store instructions (such as, for example, how to read indicia from a portable device) in a memory device such as, for example, non-volatile memory, hard drive or a flash memory.

In at least one implementation, the gaming machine may include card readers such as used with credit cards, or other identification code reading devices to allow or require player identification in connection with play of the card game and associated recording of game action. Such a user identification interface can be implemented in the form of a variety of magnetic card readers commercially available for reading a user-specific identification information. The user-specific information can be provided on specially constructed magnetic cards issued by a casino, or magnetically coded credit cards or debit cards frequently used with national credit organizations such as VISA™, MASTERCARD™, banks and/or other institutions.

The gaming machine may include other types of participant identification mechanisms which may use a fingerprint image, eye blood vessel image reader, or other suitable biological information to confirm identity of the user. Still further it is possible to provide such participant identification information by having the dealer manually code in the information in response to the player indicating his or her code name or real name. Such additional identification could also be used to confirm credit use of a smart card, transponder, and/or player's mobile device.

It will be apparent to those skilled in the art that other memory types, including various computer readable media, may be used for storing and executing program instructions pertaining to the operation EGMs described herein. Because such information and program instructions may be employed to implement the systems/methods described herein, example embodiments may relate to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Example embodiments may also be embodied in a carrier wave traveling over an appropriate medium such as airwaves, optical lines, electric lines, etc. Examples of program instructions include both machine code, such as produced by a compiler, and files including higher level code that may be executed by the computer using an interpreter.

Additional details about other gaming machine architectures, features and/or components are described, for example, in U.S. patent application Ser. No. 10/040,239, entitled, “GAME DEVELOPMENT ARCHITECTURE THAT DECOUPLES THE GAME LOGIC FROM THE GRAPHICS LOGIC,” and published on Apr. 24, 2003 as U.S. Patent Publication No. 20030078103, incorporated herein by reference in its entirety for all purposes.

FIG. 2B shows a block diagram of a specific embodiment of various gaming machine components which may be used for implementing aspects of the movable display technique of the present invention. In at least one implementation, the movable display controller 250 and its associated components may perform specific operations in response to instructions or signals received from master gaming controller 292 and/or bonus controller 280.

According to a specific embodiment, movable display controller 250 may be adapted to provide content to one or more movable displays 295. For example, as illustrated in FIG. 2B, movable display controller 250 may include one or more display controller 298 for providing and controlling content which is to be displayed on one or more of the movable displays 295. According to specific embodiments, each display controller may be associated with a respective movable display, or at least one display controller may be associated with multiple movable displays. According to a specific implementation, the display controller(s) may be implemented using at least one display adapter and/or video card that is compatible with the type of display(s) to be controlled. For example, in one implementation, display controller 298 may be operable for displaying content on movable display 295. In at least one embodiment, display controller 298 may be adapted to independently display desired content on a plurality of different movable displays.

According to specific embodiments, at least one image/graphics manipulation engine 288 may be provided. In one embodiment, the image/graphics manipulation engine 288 may include functionality for manipulating and/or modifying content (e.g., images, objects, text, graphics, etc.) to be displayed on the movable display. For example, in one embodiment, the image/graphics manipulation engine 288 may include image correction functionality for enabling content to be projected on the movable display without observable distortion effects. Such distortion effects may typically occur, for example, in a variety of situations where the angle of incidence (e.g., of the light from the projection source upon the display surface) may differ across different portions of the display surface.

For example, in specific embodiments where the movable display has a curved display surface, distortion effects involving image compaction (e.g., shortening) and/or image elongation (e.g., stretching) may be observed at various regions of the display surface. In at least one embodiment, the image/graphics manipulation engine 288 may be operable to perform one or more of the following operations: detect inconsistencies and/or irregularities (including curvatures) of the display surface; determine the relative locations and positions of the projection source(s) and display surface(s); determine the degree and/or type of graphical manipulations to be performed (e.g., on the content to be projected) in order to partially and/or substantially compensate for any distortion effects caused by the display surface inconsistencies/irregularities; perform one or more manipulations on the content to be displayed in order and enable the content to be projected onto the display surface without significant or substantially observable distortion effects, etc. Additionally, in at least some embodiments, the image/graphics manipulation engine 288 may be operable to implement its functionality in real-time (or substantially real-time) so that the content is timely displayed on the movable display in coordination with other activities (e.g., game play activities, bonus activities, etc.) being performed at the gaming machine.

According to one embodiment, different types of display content may be displayed on movable display 295. For example, a first portion of display 295 may be used to display videos or images, while a second portion of display 295 may be used to display text. Further, in at least one embodiment, multiple movable displays may be used to form a virtual display for displaying content which may span across multiple displays.

Display information and/or signals may be provided from a display controller to a movable display using a one or more standardized display protocols such as, for example: VGA, DCI, PCI, AGP, PCI Express, PCI-X, etc. Of course, other display protocols such as, for example, non-standardized display protocols, proprietary display protocols, etc. may also be used, if desired. In at least one implementation, the movable display controller 250 may include a display content module 286 configured or designed to provide display content information to selected display controllers. The display content module 286 may include memory for storing at least a portion of the display content information. In at least one embodiment, all or portions of the display content may be stored at one or more network locations and/or RF links. The display content module may also be adapted to receive display content information from different sources such as, for example, from bonus controller 280 and/or from remote sources. Such display content information may be received via one or more interfaces such as, for example, master gaming controller interfaces 291, bonus controller interfaces 281, and/or movable display controller interfaces 294. In at least one implementation, one or more of these interfaces may be configured or designed to provide a communication path for exchanging information with external devices such as, for example, other gaming machines, other bonus controllers, gaming servers, content providers, external displays, peripheral devices, etc.

As illustrated in the embodiment of FIG. 2B, movable display controller 250 may also include a virtual display module 296 configured or designed to control portions of the display content in order to enhance or modify the content to be displayed on the movable display 295. For example, the virtual display module 296 may include functionality for implementing a virtual mechanical display device such as a wheel or globe.

Another feature which may be provided by the movable display controller 250 is the ability to control the movement or motion of one or more movable displays. For example, as illustrated in FIG. 2B, movable display controller 250 may include a motion control module 284 for controlling the movement or motion of movable display 295. In this example, the movement of display 295 may be achieved using at least one motion control device 275. According to different embodiments, each motion control device may be adapted to control the movement of one or more displays.

According to a specific embodiment, the motion control device 275 may be implemented using any number of different types of motion control devices (either open or closed loop) for translating the movable displays. These types of motion control devices may include, but are not limited to, ballscrew and jacknut devices, belt and pulley devices, electromagnetic linear types of motion control devices, cam and follower devices, gear drives, leadscrews, etc. The drivers for such systems may include, for example, stepper motors, server motors, gear motors, pneumatic drivers, etc. Each of the different types of drivers may be implemented either with or without mechanical and electromechanical encoders and other feedback technologies, as desired.

As illustrated in the embodiment of FIG. 2B, one or more motion sensing device(s) 297 may be provided to detect and/or monitor motion(s) or movement(s) of the movable display 295. For example, in one embodiment, position sensing devices (such as, for example, microswitches) may be used to monitor the positions of the movable display 295 and to provide feedback to the motion control device 275, motion control module 284, and/or other components of the movable display controller 250.

According to specific embodiments, the motion sensor(s) 297 may be adapted to continually or periodically monitor the movable display 295 for any movement activity. If movement of the movable display is detected, the motion sensor(s) 297 may be operable to identify movement activity, and to determine a real-time (or substantially real-time) estimate of the directional vector(s), velocity, displacement, and/or acceleration/deceleration of display movement. In at least one embodiment, such determining may include taking periodic measurements of velocity, displacement, and/or acceleration parameters associated with one or more selected regions of the display. In some embodiments, such determining may include taking periodic measurements of velocity, displacement, and/or acceleration/deceleration parameters associated with one or more of the motion control device(s) used for imparting motion to the display.

In at least one embodiment, the motion sensor(s) 297 may be operable to generate display motion data which, for example, may be used to describe current (e.g., real-time), past and/or future motion-related characteristics of the movable display 295. For example, in one embodiment, motion sensor(s) 297 may be operable to determine: (1) a current or real-time rotational velocity of the movable display (if any), and (2) a current or real-time rotational acceleration/deceleration of the movable display (if any).

According to specific embodiments, rotational movement of the movable display may be measured and/or expressed using a variety of different parameters, such as, for example, one or more of the following (and/or combination thereof):
rotational velocity;
rotational speed (e.g., cycles per second, revolutions per second, revolutions per minute, etc.);
periodic speed (e.g., seconds per cycle, seconds per rotation, etc.);
angular speed (e.g., degrees per second, radians per second, etc);
radial frequency;
tangential speed;
etc.

Using the rotational velocity information and rotational acceleration/deceleration information, the motion sensor 297 may be operable to generate display motion data which includes information relating to motion-related characteristics of the movable display 295 such as, for example, one or more of the following: the movable display's current velocity, current acceleration/deceleration, expected future velocities for a given time interval T, expected future acceleration/deceleration for a given time interval T, etc.

In at least one alternate embodiment, the motion sensor(s) 297 may be operable to continuously or periodically determine the relative position and/or orientation of the movable display. For example, in one embodiment, the motion sensor(s) 297 may be operable to determine the relative position of the movable display every 1/30^{th} of a second. Using the real-time display position information, the motion sensor 297 may be operable to generate display motion data which includes information relating to the current position of the movable display and/or expected future positions of the movable display.

According to specific embodiments, a variety of different sensing mechanisms may be used for measuring and/or detecting motion-related characteristics (e.g., velocity, position, acceleration, deceleration, etc.) of the movable display 295. Examples of such sensing mechanisms may include, but are not limited to, one or more of the following (or combination thereof): sensors, transducers, lasers, cameras, etc.

According to specific embodiments, the Image/Motion Synchronization module 293 may be operable to utilize and lease a portion of the display motion data (e.g., generated by motion sensor 297) to coordinate the display (e.g., projection) of content (e.g., images, objects, graphics, text, symbols, etc.) on to the movable display device 295. In at least one implementation, such coordinating may include, for example, dynamically and automatically manipulating (e.g., rotating) content to be projected on the movable display so that the resulting projected content is coordinated and/or synchronized with the movement of the movable display. For example, in one embodiment, the Image/Motion Synchronization module 293 may be operable to rotate the content to be projected at a rate which substantially matches the rotational velocity of the movable display. In another embodiment, the Image/Motion Synchronization module 293 may be operable to manipulate the content to be projected so that the relative rotational orientation of the projected content (e.g., at time T1) substantially matches the relative rotational orientation of the display device (e.g., at time T1). In this way, a projected image/object is able to be continuously projected at a fixed relative location on the projection surface as the projection surface is moved (e.g., rotated).

In at least one embodiment, the Image/Motion Synchronization module 293 may utilize a combination of techniques for synchronizing the projected content with movement of the movable display device 295. For example, in one embodiment, the Image/Motion Synchronization module 293 may rotate the content (to be projected) at a rate which substantially matches the current or real-time rotational velocity of the movable display device. Additionally, at periodic intervals, the Image/Motion Synchronization module 293 may determine a current or real-time position or orientation of the movable display device, and, if necessary, may dynamically and automatically adjusts the relative orientation of the projected content to be substantially aligned with the rotational position/orientation of the display device. Such a feature may help to reduce possible “drifting” effects where the projected image drifts out of synchronization from the movement of the movable display device, for example, due to acceleration/deceleration of the movable display device.

It will be appreciated, however, that at least some situations may arise in which it is desirable to not synchronize projection of the display content with movement of the movable display device. For example, during a “spin” of a virtual mechanical bonus wheel, it may be desirable to project “blurred” images of a rotating wheel while the movable display device is rotating above a predetermined rotational velocity. Accordingly, in at least some of such situations, the functionality of the Image/Motion Synchronization module 293 may be wholly or partially disabled. Alternatively, in at least some embodiments, the Image/Motion Synchronization module 293 may be operable to synchronize a first portion of projected content with the movement of the movable display device, while allowing a second portion of projected content to not be synchronized with the movement of the movable display device.

In at least one other embodiment, a non-movable display device may be provided, and content may be projected on the non-movable display device in a manner which visually simulates a rotating mechanical wheel or sphere.

In one embodiment, hardware and/or software components may be used to coordinate the projected content with the movements of the movable display device.

According to one embodiment, it may be desirable to hide or minimize the viewable portions of the motion control device 275 from the player and/or spectators. For example, as illustrated in FIG. 1B, the motion control devices associated with moving display 145 may be located within the body of top box 111. Alternatively, the motion control devices may be displayed to the player and either themed into the game itself, or camouflaged to the extent possible to minimize its visual intrusion. In addition to hiding the motion control devices, it may be desirable at times to also utilize the movable display for different purposes at different times.

According to specific embodiments, the motion control devices may be configured or designed to provide linear and/or non-linear motion to the movable displays. Additionally the motion control devices may be configured or designed to translate the movable displays in one, two, or three dimensions.

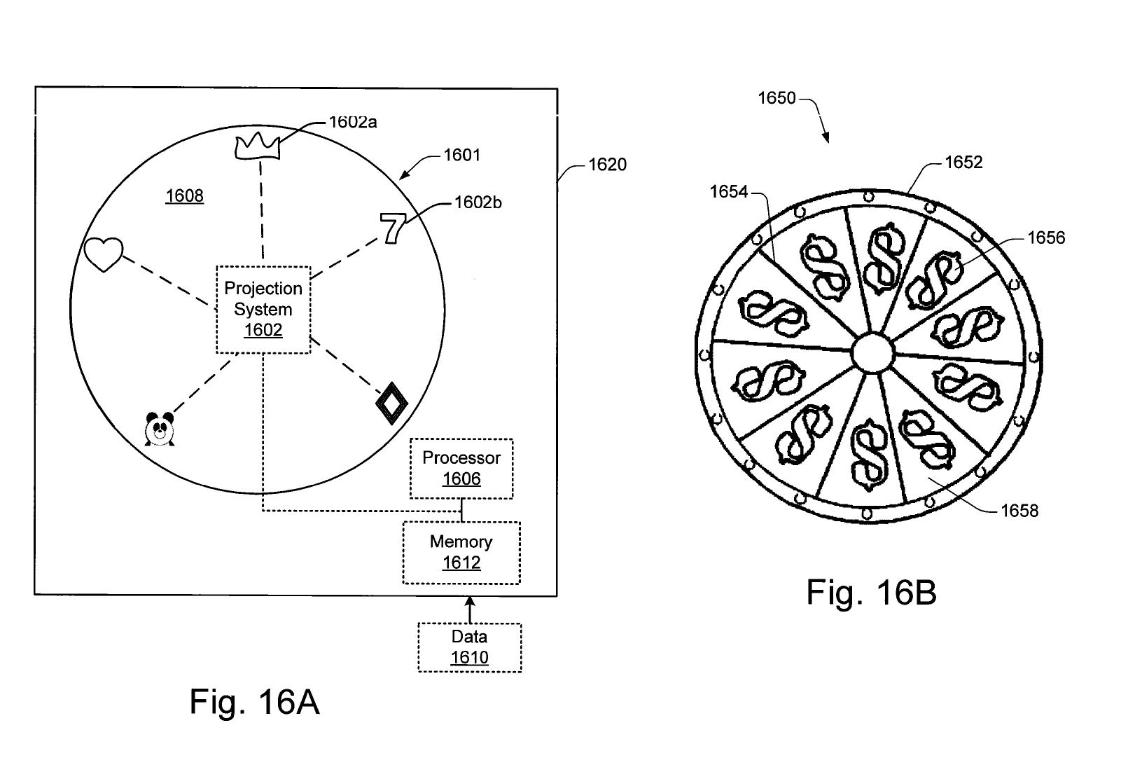

The FIG. 16A depicts an example of a gaming machine 1620 operable for implementing various features of the invention(s) described herein. Generally, gaming activity (and/or other desired activities such as, for example, bonus activity, promotional activity, attraction activity, etc.) may be conducted in connection with a plurality of images effectively provided by at least one virtual or mechanical display device. Referring to FIG. 16A, a virtual mechanical wheel 1601 is shown displaying a plurality of images or objects 1605 (e.g., 1605a, 1605b, etc.). The gaming machine 1620 effectively provides and/or implements the virtual mechanical wheel 1601 by displaying images 1605 on a projection surface 1608.

More particularly, a projection system 1602 effectively projects the images/objects 1605 on the projection surface 1608. It will be appreciated that the projected images/objects can simulate rotation of a mechanical display device, such as a wheel, disc, globe, sphere, ellipse, cube, etc. Further, those skilled in the art will appreciate that the projection system 1602 can, for example, be provided or include one or more hardware, software, and/or firmware components (or modules). Further, at least one processor 1606 may be configured for the gaming machine 1620. The processor 1606 can, for example, be a general processor provided for general processing, or a dedicated and/or specialized processor provided primarily for the projection system 1602. As such, the processor 1606 can effectively be a part of the projection system 1602 or a separate component. In any case, the processor 1606 can process data 1610 representative of the images/objects 1605. Data 1610 can, for example, be stored in internal memory 1612 and/or received via wired and/or wireless transmission from a server (or host), and/or controller device. In any case, a representative of the images/objects 1605 is processed and projected by the projection system 1602.

According to specific embodiments, the projected images/objects 1605 may be used to implement a variety of different types of operations relating to different functionalities such as, for example, game play, bonus play, promotional activities, attraction activities, information display, display of live images, etc. For example, in one embodiment, the images of one or more players may be projected onto the surface of the movable display device. In one embodiment, the player images may be captured using a video camera, such as, for example, a cell phone camera.

For example, in one embodiment, the projection system 1602 may be configured to project images/objects 1605 on the projection surface 1608 when the gaming machine 1620 is operable for playing a game and/or bonus game. Moreover, it will be appreciated that the projection system 1602 may be further configured to display the images/objects 1605 in a manner that effectively simulates or mimics a moving (e.g., rotating) mechanical display device (such as those provided by a conventional mechanical gaming machine such as, for example, the wheel associated with the well known Wheel of Fortune™ gaming machine).

As illustrated in FIG. 16A, the projection system 1602 may be configured to project images/objects 1605 on a projection surface 1608 to effectively simulate or mimic the rotation of a mechanical wheel with images/objects 1605 affixed to its surface. The images/objects may be used to determine and/or display the outcome for a game, bonus game, wagering event, etc. By way of example, the projection system 1602 can effectively simulate rotation of the virtual mechanical wheel 1601 about an axis (or multiple different axes) in a clockwise and/or counter clockwise manner. The speed and/or acceleration of the apparent rotation may effectively mimic rotation of a mechanical wheel and/or other types of mechanical display devices and figured for use with conventional gaming machines. In one embodiment, this rotation may gradually or abruptly end to display one or more images/objects (e.g., 1602a, 1062b, etc.) on the projection surface 1608 in order to determine and/or display the outcome of a particular event.

For example, in one embodiment, the outcome of a bonus game may be displayed at display 1601 by displaying specific objects (e.g., 1602a, 1602b, etc.) in a particular locations to signify a win or loss. According to specific embodiments, the projection surface 1608 may be shaped like a mechanical wheel and/or effectively provided by an object shaped like a mechanical wheel in order to more closely simulate or mimic rotation of a mechanical wheel configured for use with a conventional gaming machine. In addition, the projection surface 1608 may be operable to rotate like a mechanical wheel to provide a look and feel similar to that of a conventional mechanical wheel.

According to a specific embodiment, a processor (e.g., 1606) may be used to process data (e.g., 1610) in order to facilitate projection of images/objects on the projection surface 1608. This data can, for example, be transmitted by a server to the gaming machine 1620 and/or stored locally by the gaming machine 1620. Subsequently, the data may be processed by one or more processors. In one embodiment, the server may be operable to synchronize projection of images/objects on the projection surface 1608 with other images/objects which are projected on projection surface 1608 and/or other projection surfaces (not shown).

FIG. 16B shows an example of a projection display device 1650 in accordance with a specific embodiment. As illustrated in the example of FIG. 16B, a variety of different images/objects may be displayed via the movable projection display device 1650. Such images/objects may include, but are not limited to, one or more of the following (and/or combination thereof): graphical objects/images (e.g., 1652, 1654, 1656), patterns, lines, symbols, text, foreground/background fill (e.g., 1658), colors/shades, etc. According to specific embodiments, different projection display devices may be comprised of opaque material(s), transparent or translucent material(s) and/or some combination thereof.

In at least one embodiment, the projection system 1602 may include one or more projectors operable to project images/objects on one or more projection surfaces. According to different embodiments, one or more additional processors may be operable to facilitate coordination among the gaming machine processor(s), and/or to facilitate synchronized projection of images/objects displayed on the projection surface(s).

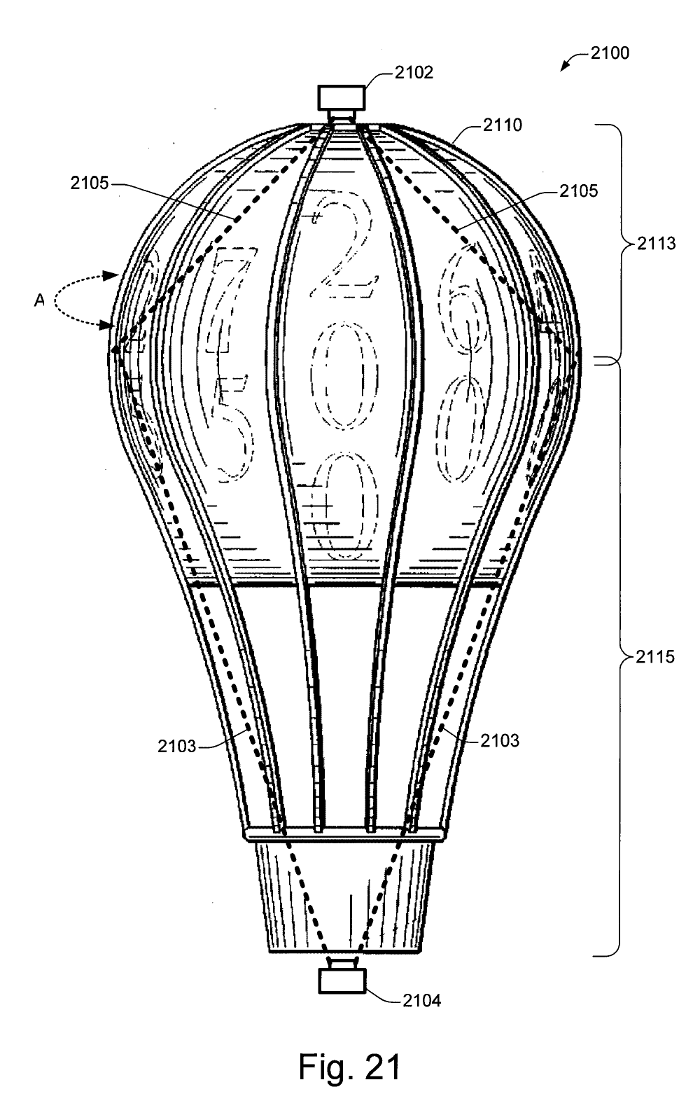

For example, FIG. 21 shows an example embodiment of a movable display system 2100 which includes a movable balloon-shaped projection surface 2110, and multiple projection sources, namely projectors 2102, 2104. As illustrated in the example of FIG. 21, projector 2102 is operable for projecting images/objects on a first portion (e.g., 2115) of the projection surface, and projector 2104 is operable for projecting images/objects on a second portion (e.g., 2113) of the projection surface. In at least some embodiments (as shown, for example, in FIG. 21), there may be some overlap of projection surface regions covered by the first and second portions. In at least one embodiment, content of images/objects projected by projectors 2102 and 2104 onto projection surface 2110 may be coordinated in a manner which results in a relatively seamless appearance, as viewed, for example, by a player or other casino patron. Additionally, in at least one embodiment, projection of the images/objects by each projector may be synchronized with the movement (e.g., rotation) of projection surface 2110 in order, for example, to enable a projected image/object to remain at a fixed relative location on the projection surface as the projection surface is moved (e.g., rotated). According to specific embodiments, aspects relating to such content coordination and/or synchronization operations may be implemented at the gaming machine, remote server and/or some combination thereof.

Although not specifically illustrated in FIG. 21, bearings (or support blocks) may be provided to support rotation of the projection surface 2110. In one embodiment, a stepper motor (or DC motor) may be operable to engage a series of gears, pulleys, and/or friction wheels to effectively rotate the projection surface around a vertical axis. In at least one embodiment, each projection device 2102, 2104 may include a projection engine and lens, and may be operable to project images/objects on the projection surface as it rotates or is in a stationary position. Additionally, in at least some embodiments, mirrors may also be used reflect projected on to desired portions of the projection surface.

In one embodiment, the projection engine may, for example, include a Digital Light Processing (DLP) engine. As such, any DLP projection content may be used for projection of images/objects on the surface of the projection surface. DLP technology is generally known to those skilled in the art. It should be noted that other projection technologies may be used. One such technology is generally known as LCos (Liquid Crystal on silicon) which can effectively create images/objects using a stationary mirror mounted on the surface of a chip and using a liquid crystal matrix to control how much light is reflected.

In order to project over a relatively larger area, one or more lenses may be utilized. According to specific embodiments, some lenses may differ from conventional convex-type lenses. Examples of different lens types/configurations which may be used may include, but are not limited to, one or more of the following (and/or combination thereof): lenses having a constant radius R; lenses having a variable radius (e.g., R1, R2 R3), etc.

Additionally, in at least some embodiments, “pixel-warping” may be utilized to achieve a desired display effect using, for example, a conventional convex-type lens. In one embodiment, pixel-warping may be achieved by digitally manipulating pixels, for example, by using a Silicon Optics Pixel Warping chip (available from Silicon Optics www.siliconoptix.com).

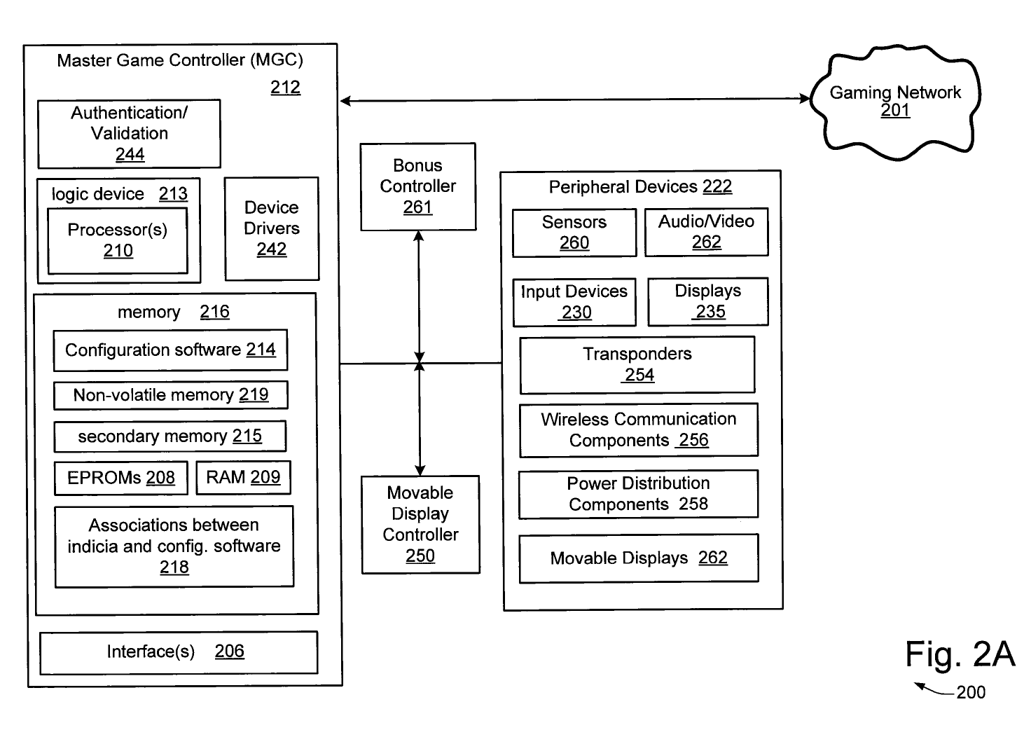

FIGS. 3A and 3B show examples of specific embodiments of movable virtual mechanical display device which utilizes a front projection system for projecting images/objects (e.g., 304) onto a movable circular disc-shaped display device (e.g., 302). In at least one embodiment, the disc-shaped display device is rotatable in clockwise and/or counter-clockwise direction(s). As illustrated in the example of FIG. 3B, the disc-shaped display device (e.g., 352) is substantially flat in shape. In at least one embodiment, the disc-shaped display device 352 is operable to rotate about a central axis or hub (e.g., 358).

As illustrated in the embodiment of FIG. 3B, rotational motion may be imparted to disc-shaped display device 352 via stepper motor 356, and shaft 357. In alternate embodiments, other types of motion control devices may be used to impart motion upon the display device. An image/object projection mechanism (e.g., projector 360) may be used to project (e.g., 354) images/objects onto a front surface (e.g., 359) of the disc-shaped display device 352. In at least one embodiment, projection of the images/objects may be coordinated with the stepper motor rotation in order, for example, to enable a projected object/image to remain at a fixed relative location on the surface of the display device during times when the display device is being rotated and/or during times when the display device is stationary.

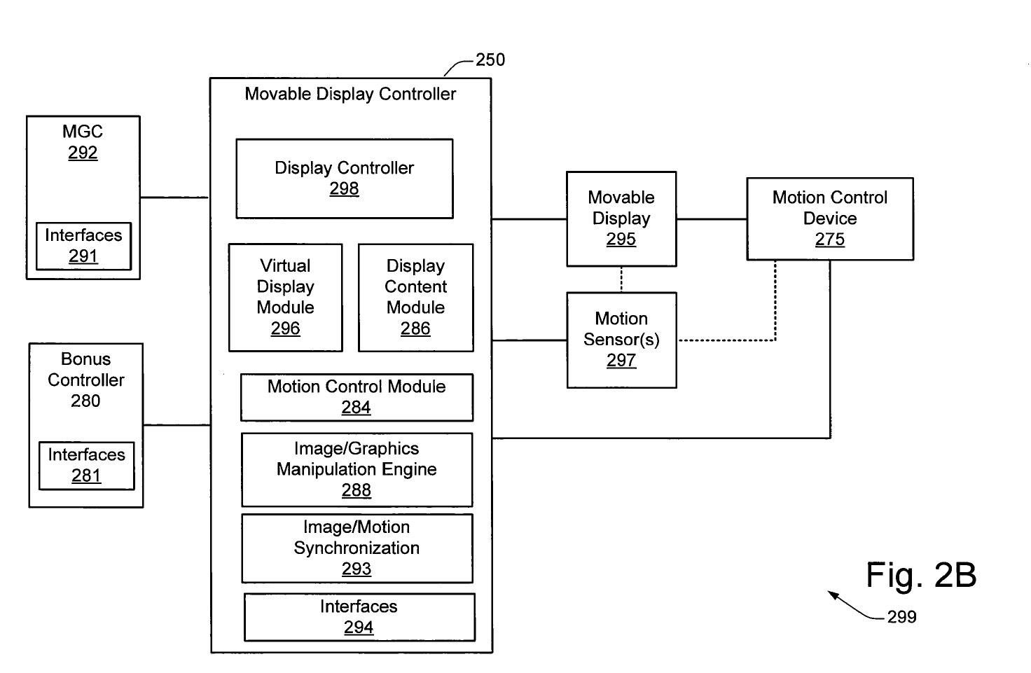

FIGS. 4A and 4B show examples of specific embodiments of movable virtual mechanical display device which utilizes a rear projection system for projecting images/objects (e.g., 404) onto a movable disc-shaped display device (e.g., 402). In at least one embodiment, the disc-shaped display device is rotatable in clockwise and/or counter-clockwise direction(s). For example, as shown in FIG. 4A, a pinion gear 401 and ring gear 403 may be used to impart motion of the display device 402.

As illustrated in the example of FIG. 4B, the disc-shaped display device (e.g., 452) is substantially flat in shape. In at least one embodiment, the display device 452 is operable to rotate about a central axis or hub (e.g., 458). According to specific embodiments, rotational motion may be imparted to display device 452 via a variety of different types of motion control devices. For example, in the embodiment of FIG. 4B, rotational motion may be imparted to display device 452 via stepper motor 456, pinion gear 451, and ring gear 453.

An image/object projection mechanism (e.g., projector 460) may be used to project (e.g., 454) images/objects onto a rear surface (e.g., 459) of the disc-shaped display device 452. In at least one embodiment, the display device 452 may be comprised of a transparent and/or translucent material in order to allow the projected images/objects to be viewed from the front side of the display device (e.g., side opposite to the rear surface 459). Examples of suitable transparent and/or translucent materials may include, but are not necessarily limited to: clear acrylic material, white translucent acrylic, glass, screen printed acrylic or glass with blank windows that allowed an image to be transmitted and viewed upon, flexible film such as the type used for spinning reels, etc.

In at least one embodiment, projection of the images/objects may be coordinated with the stepper motor rotation in order, for example, to enable a projected object to remain at a fixed relative location on the surface of the display device during times when the display device is being rotated and/or during times when the display device is stationary.

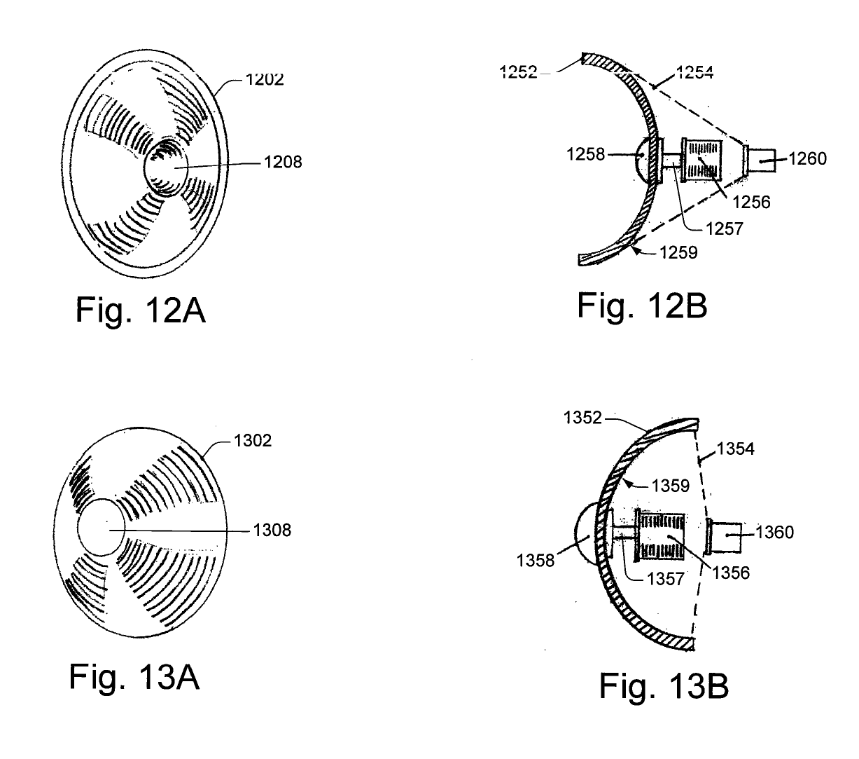

FIGS. 14A and 14B show alternate embodiments of a movable virtual mechanical display device which utilizes a rear projection system for projecting images/objects onto a movable disc-shaped display device. As illustrated in the example of FIG. 14B, rotational motion may be imparted to display device 1452 via stepper motor 1456 and shaft 1457. In alternate embodiments, other types of motion control devices may be used for imparting motion to display device 1452. An image/object projection mechanism (e.g., projector 1460) may be used to project (e.g., 1454) images/objects onto a rear surface (e.g., 1459) of the display device 1452. In at least one embodiment, the display device 1452 may be comprised of a transparent and/or translucent material in order to allow the projected images/objects to be viewed from the front side of the display device (e.g., side opposite to the rear surface 1459). According to specific embodiments, the relative distance and positions of the projector 1460 and drive mechanism (e.g., stepper motor 1456) may be adjusted, as desired, to vary the position and degree of distortion effects and/or shadowing effects (e.g., darkness shadows which may be caused by the stepper motor or other devices preventing some of the projected light from reaching the display surface 1459).

As can readily be observed from the drawings, the hub portion 458 of the display of FIG. 4B is configured as a recessed-type hub, whereas the hub portion 1458 of the display of FIG. 14B is configured as a non-recessed or protruding-type hub. According to different embodiments, the size and shape of the hub portion may be varied, as desired. For example, in one embodiment, the hub portion 1458 of FIG. 14B may be comprised of an opaque material, and may be configured to generally have a size and shape which effectively obscures view of the shadow region of the display which is attributable to the stepper motor preventing some of the projected light from reaching the display surface.

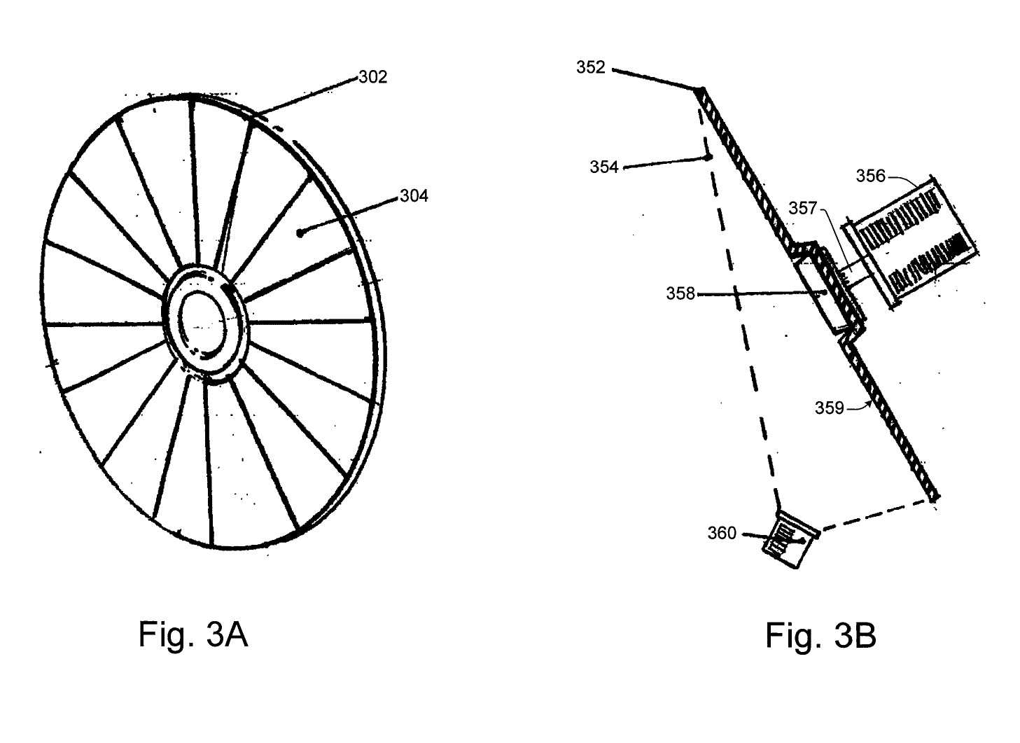

FIGS. 5A and 5B show examples of specific embodiments of movable virtual mechanical display device which utilizes a front projection system for projecting images/objects (e.g., 504) onto a movable circular cone-shaped display device (e.g., 502). In at least one embodiment, the cone-shaped display device is rotatable in clockwise and/or counter-clockwise direction(s). As illustrated in the example of FIG. 5B, the cone-shaped display device (e.g., 552) is substantially conical in shape. In at least one embodiment, the cone-shaped display device 552 is operable to rotate about a central axis or hub (e.g., 558).

As illustrated in the embodiment of FIG. 5B, rotational motion may be imparted to cone-shaped display device 552 via stepper motor 556, and shaft 557. In alternate embodiments, other types of motion control devices may be used to impart motion upon the display device. An image/object projection mechanism (e.g., projector 560) may be used to project (e.g., 554) images/objects onto a front surface (e.g., 559) of the cone-shaped display device 552. In at least one embodiment, projection of the images/objects may be coordinated with the stepper motor rotation in order, for example, to enable a projected object/image to remain at a fixed relative location on the surface of the display device during times when the display device is being rotated and/or during times when the display device is stationary.

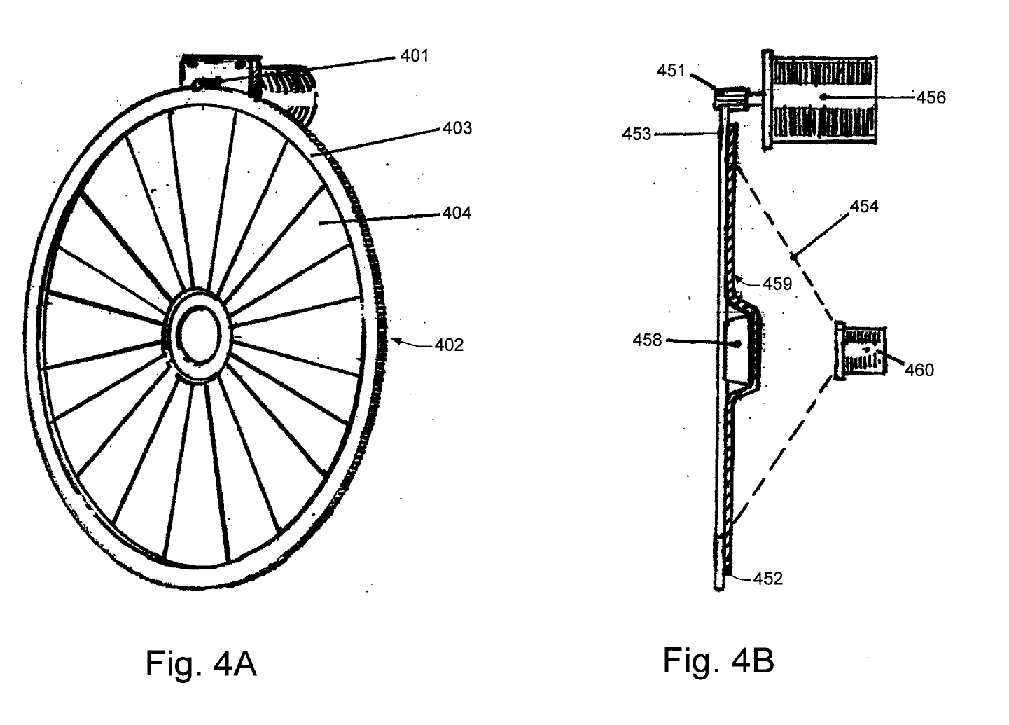

FIGS. 6A and 6B show examples of specific embodiments of movable virtual mechanical display device which utilizes a rear projection system for projecting images/objects (e.g., 604) onto a movable cone-shaped display device (e.g., 602). In at least one embodiment, the cone-shaped display device is rotatable in clockwise and/or counter-clockwise direction(s). For example, as shown in FIG. 6A, a pinion gear 601 and ring gear 603 may be used to impart motion of the display device 602.

As illustrated in the example of FIG. 6B, the cone-shaped display device (e.g., 652) is substantially conical in shape. In at least one embodiment, the display device 652 is operable to rotate about a central axis or hub (e.g., 658). According to specific embodiments, rotational motion may be imparted to display device 652 via a variety of different types of motion control devices. For example, in the embodiment of FIG. 6B, rotational motion may be imparted to display device 652 via stepper motor 656, pinion gear 651, and ring gear 653.

An image/object projection mechanism (e.g., projector 660) may be used to project (e.g., 654) images/objects onto a rear surface (e.g., 659) of the cone-shaped display device 652. In at least one embodiment, the display device 652 may be comprised of a transparent and/or translucent material in order to allow the projected images/objects to be viewed from the front side of the display device (e.g., side opposite to the rear surface 659). In at least one embodiment, projection of the images/objects may be coordinated with the stepper motor rotation in order, for example, to enable a projected object to remain at a fixed relative location on the surface of the display device during times when the display device is being rotated and/or during times when the display device is stationary.

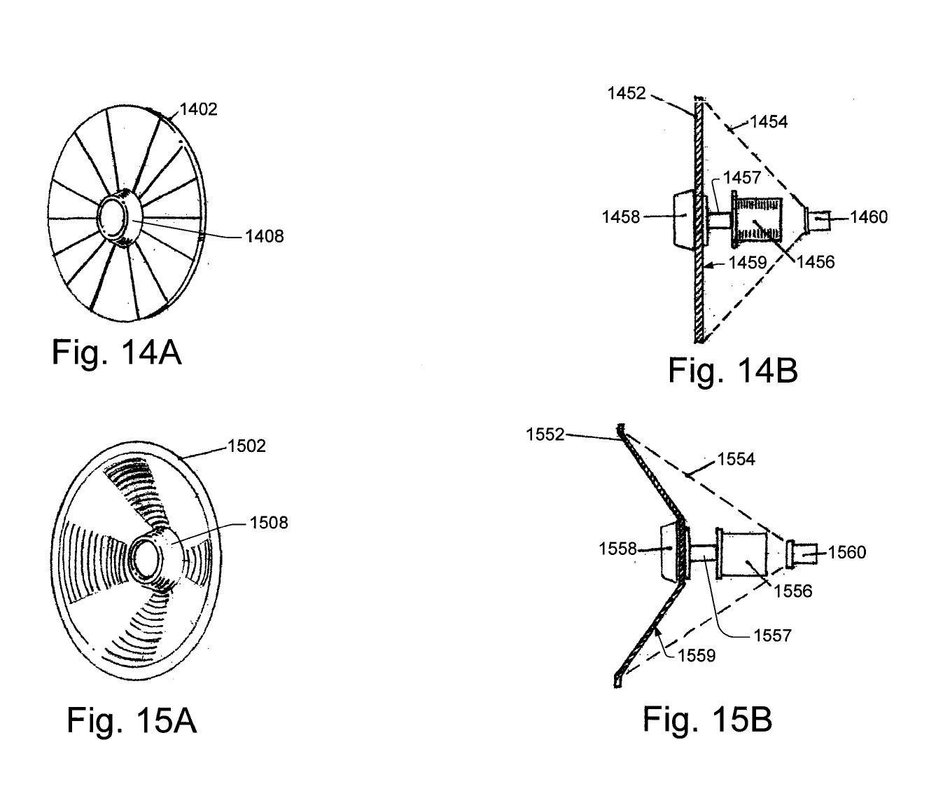

FIGS. 15A and 15B show alternate embodiments of a movable virtual mechanical display device which utilizes a rear projection system for projecting images/objects onto a movable cone-shaped display device. As illustrated in the example of FIG. 15B, rotational motion may be imparted to display device 1552 via stepper motor 1556 and shaft 1557. In alternate embodiments, other types of motion control devices may be used for imparting motion to display device 1552. An image/object projection mechanism (e.g., projector 1560) may be used to project (e.g., 1554) images/objects onto a rear surface (e.g., 1559) of the display device 1552. In at least one embodiment, the display device 1552 may be comprised of a transparent and/or translucent material in order to allow the projected images/objects to be viewed from the front side of the display device (e.g., side opposite to the rear surface 1559). According to specific embodiments, the relative distance and positions of the projector 1560 and drive mechanism (e.g., stepper motor 1556) may be adjusted, as desired, to vary the position and degree of distortion effects and/or shadowing effects (e.g., darkness shadows which may be caused by the stepper motor or other devices preventing some of the projected light from reaching the display surface 1559).

As can readily be observed from the drawings, the hub portion 658 of the display of FIG. 6B is configured as a recessed-type hub, whereas the hub portion 1558 of the display of FIG. 15B is configured as a non-recessed or protruding-type hub. According to different embodiments, the size and shape of the hub portion may be varied, as desired. For example, in one embodiment, the hub portion 1558 of FIG. 15B may be comprised of an opaque material, and may be configured to generally have a size and shape which effectively obscures view of the shadow region of the display which is attributable to the stepper motor preventing some of the projected light from reaching the display surface.

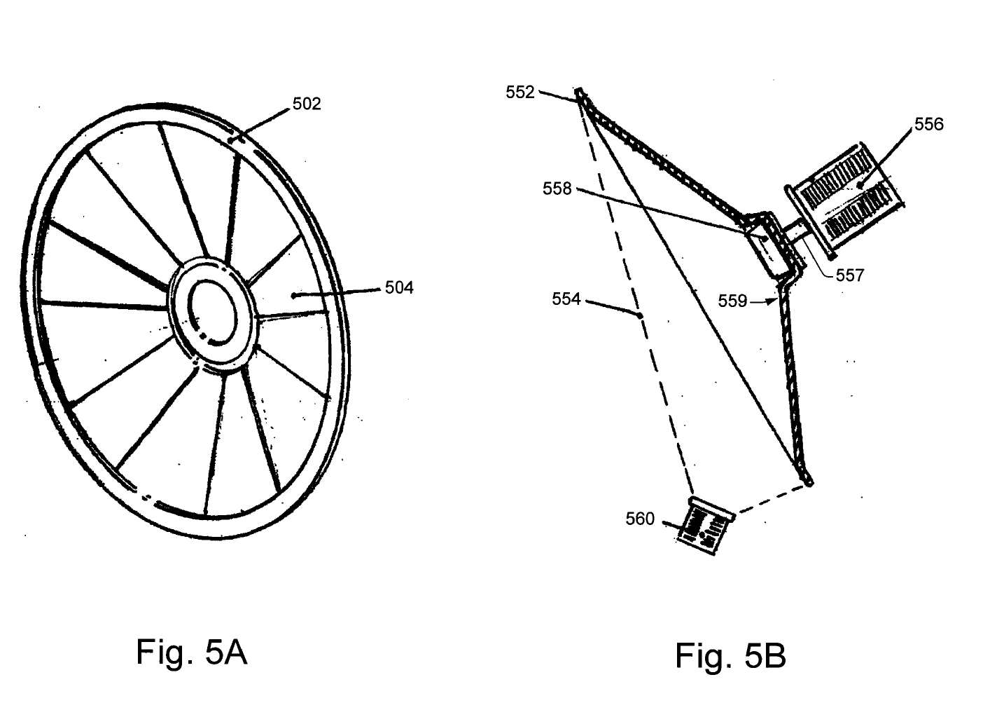

FIGS. 7A and 7B show examples of specific embodiments of movable virtual mechanical display device which utilizes a front projection system for projecting images/objects (e.g., 704) onto a movable circular concave-shaped display device (e.g., 702). In at least one embodiment, the concave-shaped display device is rotatable in clockwise and/or counter-clockwise direction(s). As illustrated in the example of FIG. 7B, the concave-shaped display device (e.g., 752) is substantially concave in shape. In at least one embodiment, the concave-shaped display device 752 is operable to rotate about a central axis or hub (e.g., 758).

As illustrated in the embodiment of FIG. 7B, rotational motion may be imparted to concave-shaped display device 752 via stepper motor 756, and shaft 757. In alternate embodiments, other types of motion control devices may be used to impart motion upon the display device. An image/object projection mechanism (e.g., projector 760) may be used to project (e.g., 754) images/objects onto a front surface (e.g., 759) of the concave-shaped display device 752. In at least one embodiment, projection of the images/objects may be coordinated with the stepper motor rotation in order, for example, to enable a projected object/image to remain at a fixed relative location on the surface of the display device during times when the display device is being rotated and/or during times when the display device is stationary.

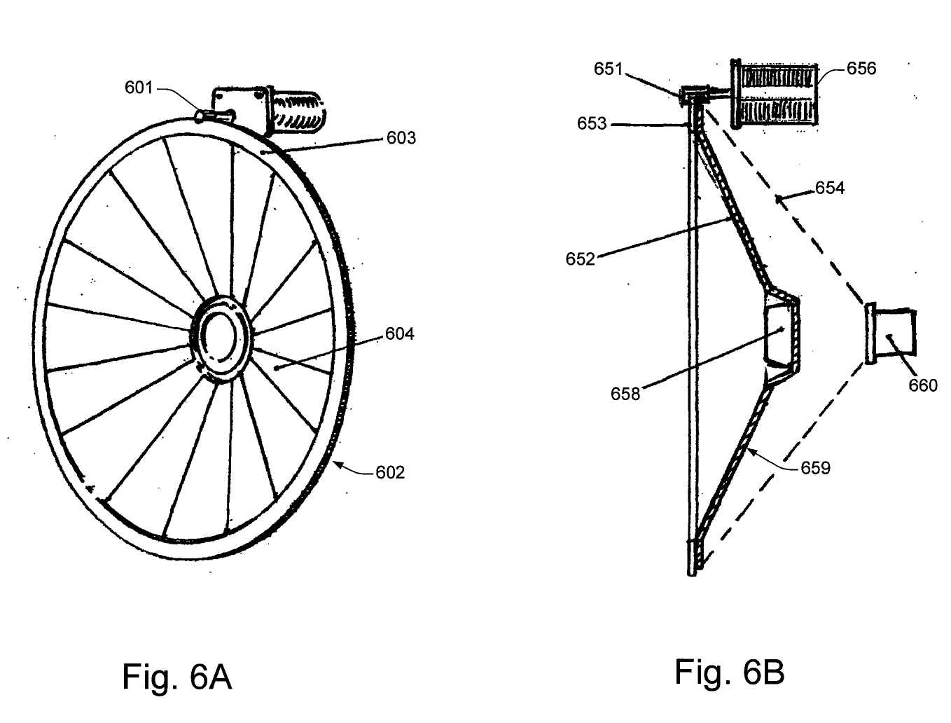

FIGS. 8A and 8B show examples of specific embodiments of movable virtual mechanical display device which utilizes a rear projection system for projecting images/objects (e.g., 804) onto a movable concave-shaped display device (e.g., 802). In at least one embodiment, the concave-shaped display device is rotatable in clockwise and/or counter-clockwise direction(s). For example, as shown in FIG. 8A, a pinion gear 801 and ring gear 803 may be used to impart motion of the display device 802.

As illustrated in the example of FIG. 8B, the concave-shaped display device (e.g., 852) is substantially concave in shape. In at least one embodiment, the display device 852 is operable to rotate about a central axis or hub (e.g., 858). According to specific embodiments, rotational motion may be imparted to display device 852 via a variety of different types of motion control devices. For example, in the embodiment of FIG. 8B, rotational motion may be imparted to display device 852 via stepper motor 856, pinion gear 851, and ring gear 853.

An image/object projection mechanism (e.g., projector 860) may be used to project (e.g., 854) images/objects onto a rear surface (e.g., 859) of the concave-shaped display device 852. In at least one embodiment, the display device 852 may be comprised of a transparent and/or translucent material in order to allow the projected images/objects to be viewed from the front side of the display device (e.g., side opposite to the rear surface 859). In at least one embodiment, projection of the images/objects may be coordinated with the stepper motor rotation in order, for example, to enable a projected object to remain at a fixed relative location on the surface of the display device during times when the display device is being rotated and/or during times when the display device is stationary.

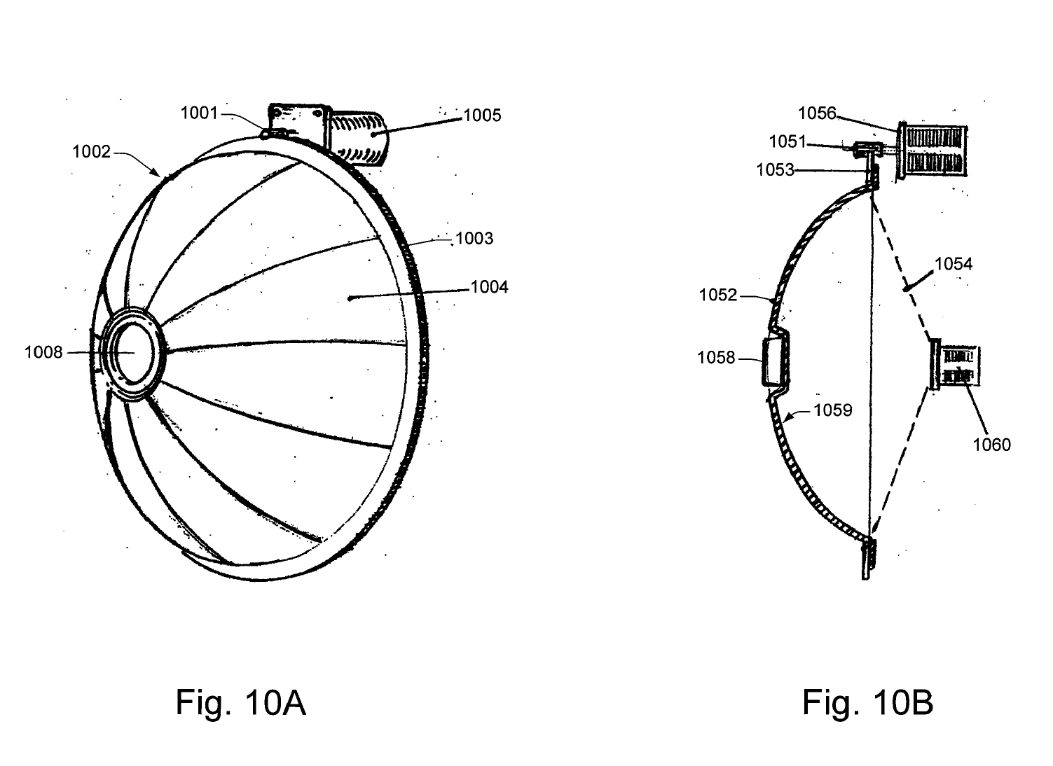

FIGS. 12A and 12B show alternate embodiments of a movable virtual mechanical display device which utilizes a rear projection system for projecting images/objects onto a movable concave-shaped display device. As illustrated in the example of FIG. 12B, rotational motion may be imparted to display device 1252 via stepper motor 1256 and shaft 1257. In alternate embodiments, other types of motion control devices may be used for imparting motion to display device 1252. An image/object projection mechanism (e.g., projector 1260) may be used to project (e.g., 1254) images/objects onto a rear surface (e.g., 1259) of the display device 1252. In at least one embodiment, the display device 1252 may be comprised of a transparent and/or translucent material in order to allow the projected images/objects to be viewed from the front side of the display device (e.g., side opposite to the rear surface 1259). According to specific embodiments, the relative distance and positions of the projector 1260 and drive mechanism (e.g., stepper motor 1256) may be adjusted, as desired, to vary the position and degree of distortion effects and/or shadowing effects (e.g., darkness shadows which may be caused by the stepper motor or other devices preventing some of the projected light from reaching the display surface 1259).

As can readily be observed from the drawings, the hub portion 858 of the display of FIG. 8B is configured as a recessed-type hub, whereas the hub portion 1258 of the display of FIG. 12B is configured as a non-recessed or protruding-type hub. According to different embodiments, the size and shape of the hub portion may be varied, as desired. For example, in one embodiment, the hub portion 1258 of FIG. 12B may be comprised of an opaque material, and may be configured to generally have a size and shape which effectively obscures view of the shadow region of the display which is attributable to the stepper motor preventing some of the projected light from reaching the display surface.

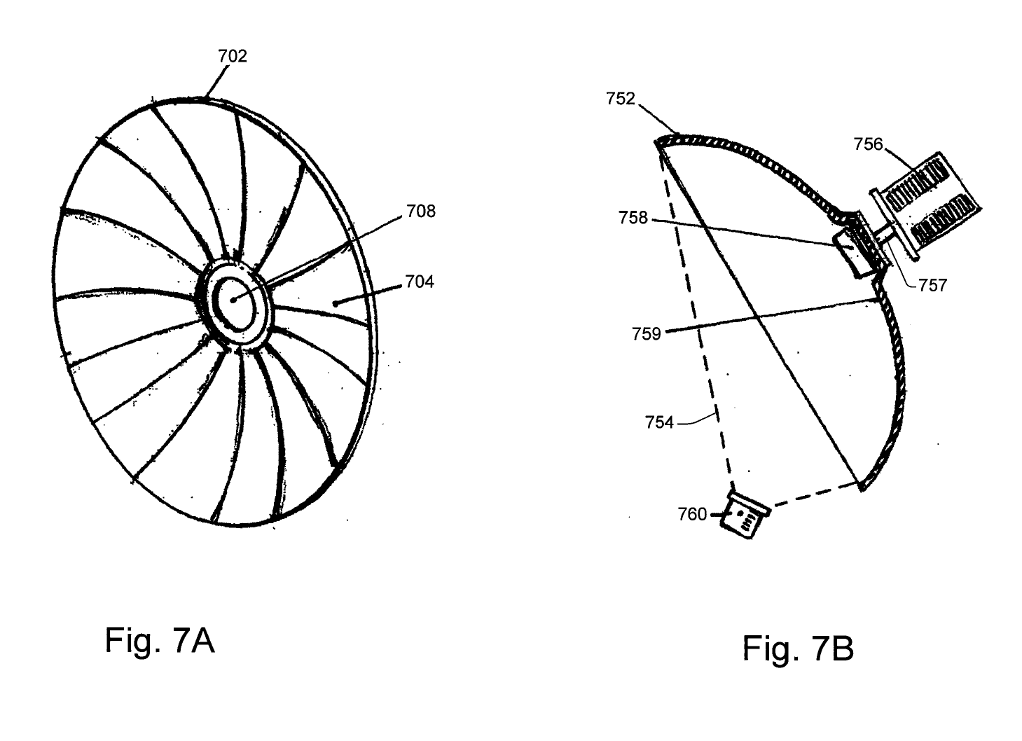

FIGS. 9A and 9B show examples of specific embodiments of movable virtual mechanical display device which utilizes a front projection system for projecting images/objects (e.g., 904) onto a movable circular convex-shaped display device (e.g., 902). In at least one embodiment, the convex-shaped display device is rotatable in clockwise and/or counter-clockwise direction(s). As illustrated in the example of FIG. 9B, the convex-shaped display device (e.g., 952) is substantially convex in shape. In at least one embodiment, the convex-shaped display device 952 is operable to rotate about a central axis or hub (e.g., 958).

As illustrated in the embodiment of FIG. 9B, rotational motion may be imparted to convex-shaped display device 952 via stepper motor 956, and shaft 957. In alternate embodiments, other types of motion control devices may be used to impart motion upon the display device. An image/object projection mechanism (e.g., projector 960) may be used to project (e.g., 954) images/objects onto a front surface (e.g., 959) of the convex-shaped display device 952. In at least one embodiment, projection of the images/objects may be coordinated with the stepper motor rotation in order, for example, to enable a projected object/image to remain at a fixed relative location on the surface of the display device during times when the display device is being rotated and/or during times when the display device is stationary.

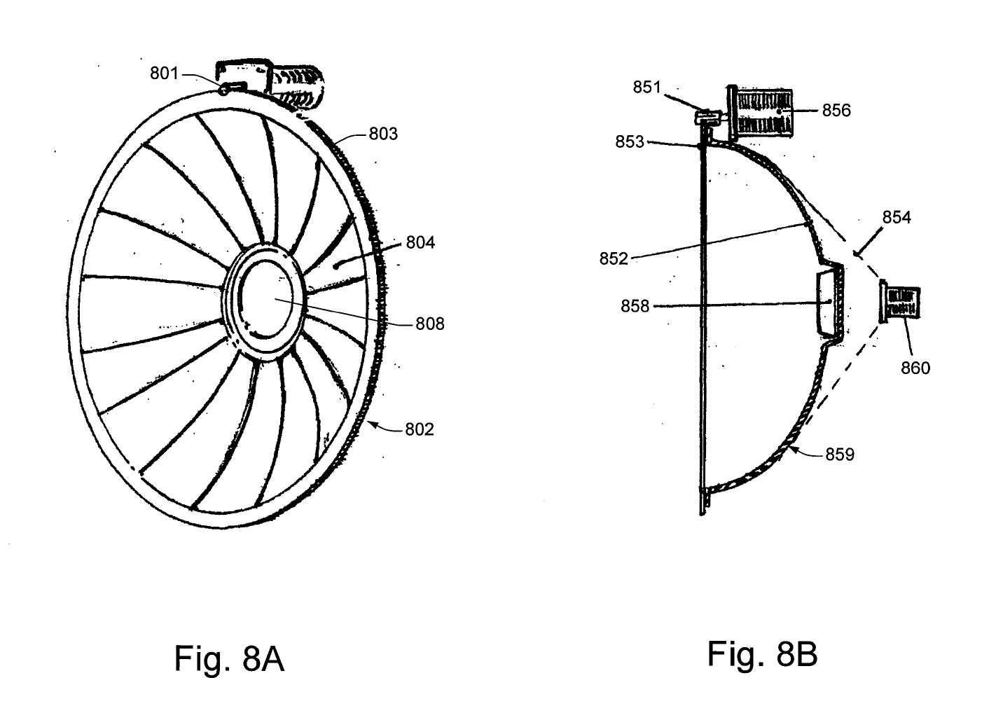

FIGS. 10A and 10B show examples of specific embodiments of movable virtual mechanical display device which utilizes a rear projection system for projecting images/objects (e.g., 1004) onto a movable convex-shaped display device (e.g., 1002). In at least one embodiment, the convex-shaped display device is rotatable in clockwise and/or counter-clockwise direction(s). For example, as shown in FIG. 10A, a pinion gear 1001 and ring gear 1003 may be used to impart motion of the display device 1002.

As illustrated in the example of FIG. 10B, the convex-shaped display device (e.g., 1052) is substantially convex in shape. In at least one embodiment, the display device 1052 is operable to rotate about a central axis or hub (e.g., 1058). According to specific embodiments, rotational motion may be imparted to display device 1052 via a variety of different types of motion control devices. For example, in the embodiment of FIG. 10B, rotational motion may be imparted to display device 1052 via stepper motor 1056, pinion gear 1051, and ring gear 1053.

An image/object projection mechanism (e.g., projector 1060) may be used to project (e.g., 1054) images/objects onto a rear surface (e.g., 1059) of the convex-shaped display device 1052. In at least one embodiment, the display device 1052 may be comprised of a transparent and/or translucent material in order to allow the projected images/objects to be viewed from the front side of the display device (e.g., side opposite to the rear surface 1059). In at least one embodiment, projection of the images/objects may be coordinated with the stepper motor rotation in order, for example, to enable a projected object to remain at a fixed relative location on the surface of the display device during times when the display device is being rotated and/or during times when the display device is stationary.

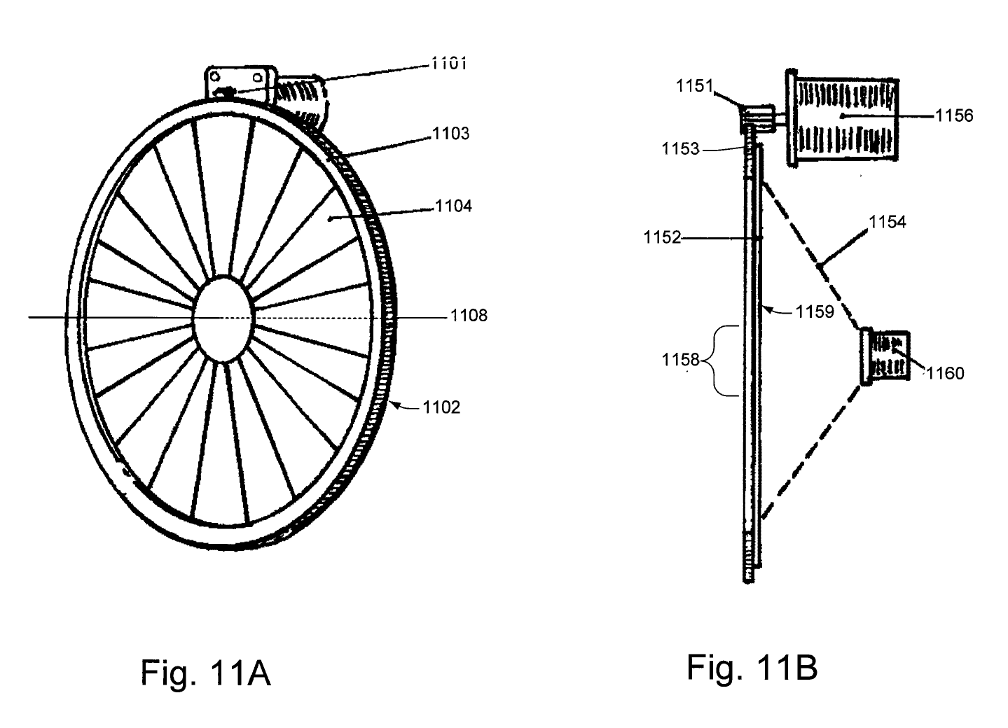

FIGS. 13A and 13B show alternate embodiments of a movable virtual mechanical display device which utilizes a rear projection system for projecting images/objects onto a movable convex-shaped display device. As illustrated in the example of FIG. 13B, rotational motion may be imparted to display device 1352 via stepper motor 1356 and shaft 1357. In alternate embodiments, other types of motion control devices may be used for imparting motion to display device 1352. An image/object projection mechanism (e.g., projector 1360) may be used to project (e.g., 1354) images/objects onto a rear surface (e.g., 1359) of the display device 1352. In at least one embodiment, the display device 1352 may be comprised of a transparent and/or translucent material in order to allow the projected images/objects to be viewed from the front side of the display device (e.g., side opposite to the rear surface 1359). According to specific embodiments, the relative distance and positions of the projector 1360 and drive mechanism (e.g., stepper motor 1356) may be adjusted, as desired, to vary the position and degree of distortion effects and/or shadowing effects (e.g., darkness shadows which may be caused by the stepper motor or other devices preventing some of the projected light from reaching the display surface 1359).

As can readily be observed from the drawings, the hub portion 1058 of the display of FIG. 10B is configured as a recessed-type hub, whereas the hub portion 1358 of the display of FIG. 13B is configured as a non-recessed or protruding-type hub. According to different embodiments, the size and shape of the hub portion may be varied, as desired. For example, in one embodiment, the hub portion 1358 of FIG. 13B may be comprised of an opaque material, and may be configured to generally have a size and shape which effectively obscures view of the shadow region of the display which is attributable to the stepper motor preventing some of the projected light from reaching the display surface.

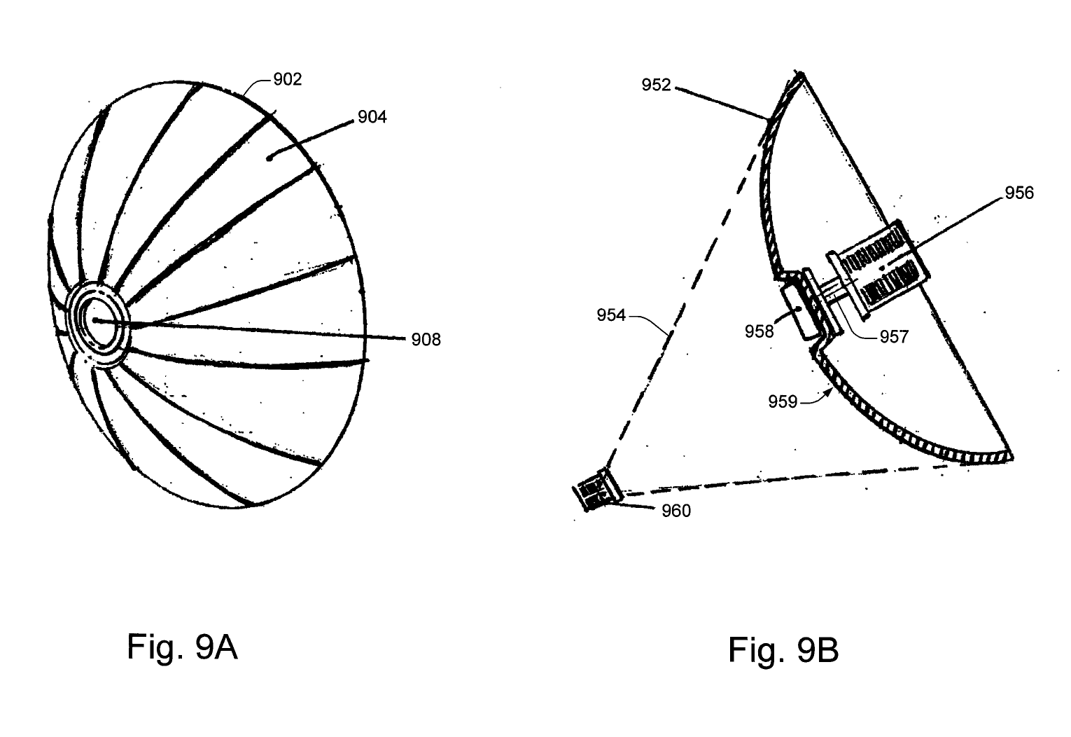

FIGS. 11A and 11B show examples of specific embodiments of movable virtual mechanical display device which utilizes a rear projection system for projecting images/objects (e.g., 1104) onto a movable disc-shaped display device (e.g., 1102). In at least one embodiment, the disc-shaped display device is rotatable in clockwise and/or counter-clockwise direction(s). For example, as shown in FIG. 1A, a pinion gear 1101 and ring gear 1103 may be used to impart motion of the display device 1102. In at least one embodiment, the display device 1102 is operable to rotate about a central axis 1108.

As illustrated in the example of FIG. 11B, the disc-shaped display device (e.g., 1152) is substantially flat in shape. According to specific embodiments, rotational motion may be imparted to display device 1152 via a variety of different types of motion control devices. For example, in the embodiment of FIG. 11B, rotational motion may be imparted to display device 1152 via stepper motor 1156, pinion gear 1151, and ring gear 1153. Additional gears and/or bearings (not shown) may be positioned at lower portion(s) of the display device, and may be operable to provide structural support for the display device, and/or to facilitate, regulate and/or control movement of the display device.

An image/object projection mechanism (e.g., projector 1160) may be used to project (e.g., 1154) images/objects onto a rear surface (e.g., 1159) of the disc-shaped display device 1152. In at least one embodiment, the display device 1152 may be comprised of a transparent and/or translucent material in order to allow the projected images/objects to be viewed from the front side of the display device (e.g., side opposite to the rear surface 1159).

As illustrated in the embodiment of FIG. 11B, the display device is configured as a hubless display device. Accordingly, in at least one embodiment, images/objects may be projected onto the central portion (e.g., region 1158) of the display surface 1159, and subsequently viewed from the front side of the display device.

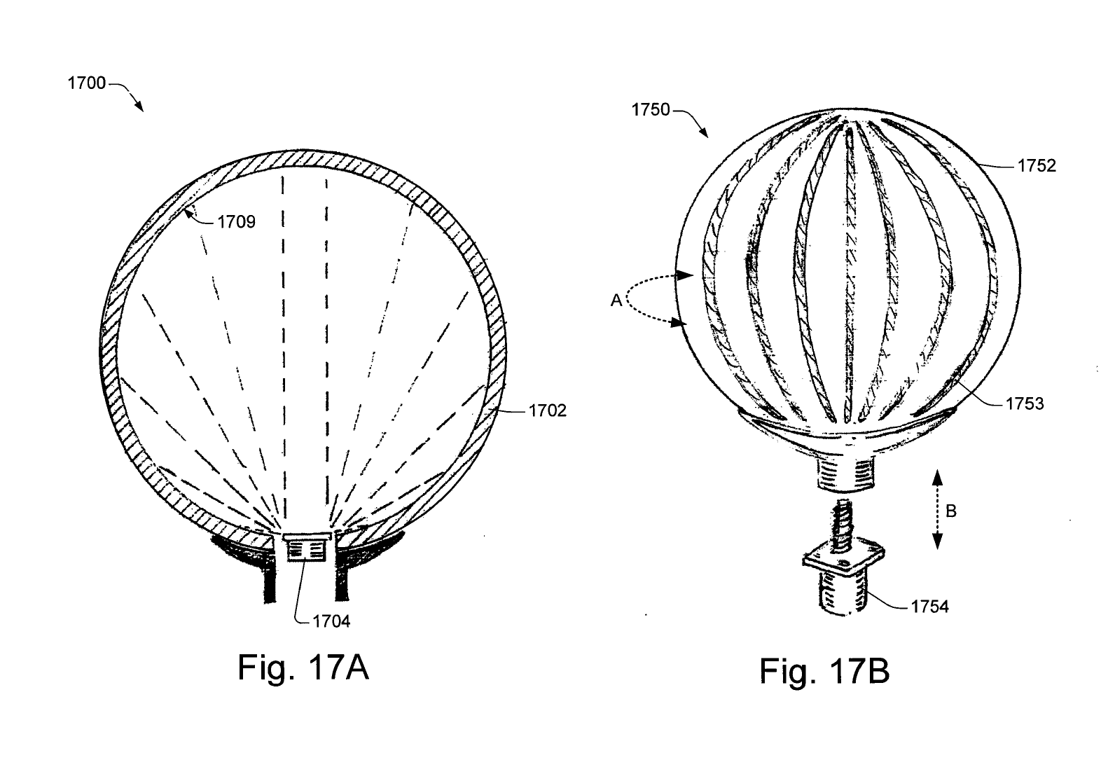

FIGS. 17A and 17B show examples of specific embodiments of movable virtual mechanical display device which utilizes an internal projection system for projecting images/objects onto a movable sphere-shaped display device (e.g., 1702). In at least one embodiment, the sphere-shaped display device is rotatable in clockwise and/or counter-clockwise direction(s). As shown in the example of FIG. 17A, a projection device (e.g., projector 1704) may be used to project images/objects onto the inner display surface 1709. In at least one embodiment, the display device 1702 may be comprised of a transparent and/or translucent material (e.g., clear acrylic material) in order to allow the projected images/objects to be observable from the outside side of the sphere. In at least one embodiment, the movable virtual mechanical display system 1700 illustrated in FIG. 17A may be operable to simulate or mimic the appearance of a moving (e.g., rotating) mechanical sphere-shaped display device (such as, for example, the bonus sphere associated with the well known Star Wars™ gaming machine.

As illustrated in the example of FIG. 17B, the sphere-shaped display device (e.g., 1752) is substantially spherical in shape. In alternate embodiments (not shown) the display device may be configured using other types of shapes such as, for example: ovals, triangles, rectangles, trapezoids, etc. In at least one embodiment, the sphere-shaped display device 1752 is operable to rotate about a central axis. As illustrated in the embodiment of FIG. 17B, rotational motion may be imparted to sphere-shaped display device 1752 via stepper motor 1754. In alternate embodiments, other types of motion control devices may be used to impart motion upon the display device. An image/object projection mechanism may be used to project images/objects (e.g., 1753) onto the inner surface of the sphere-shaped display device. In at least one embodiment, projection of the images/objects may be coordinated with the stepper motor rotation in order, for example, to enable a projected object/image to remain at a fixed relative location on the surface of the display device during times when the display device is being rotated and/or during times when the display device is stationary. Additionally, in at least some embodiments, the display device 1752 may be operable to move in vertical and/or horizontal directions. For example, as illustrated in the embodiment of FIG. 17B, the display device 1752 may be operable to be raised and/or lowered. In one embodiment, the stepper motor 1754 may be operable to rotate the display device on a substantially horizontal axis. Additionally, the stepper motor may include a threaded drive shaft which allows may be used for raising and/or lowering the sphere-shaped display device 1752, for example, in the directions indicated by the directional arrows identified by reference character B of FIG. 17B.

According to various embodiments, one or more of the movable virtual mechanical display devices described herein may be utilized in a variety of systems such as, for example, one or more of the following (or combinations thereof): single-player gaming machines, multi-player gaming systems, tournament game play systems, entertainment systems, promotion systems, bonus game play systems, player tracking systems, security systems, etc. In at least some embodiments, the movable virtual mechanical display device may be automatically and/or dynamically configurable (e.g., in real-time) in order to allow the movable virtual mechanical display device to be used in conjunction with a variety of different gaming and/or non-gaming related activities such as, for example: game play activities, tournament play activities, promotional activities, bonus activities, attraction activities, etc.

FIG. 19 shows a flow diagram of a Mechanical Display Virtualization Procedure 1900 in accordance with a specific embodiment. In at least one embodiment, the Mechanical Display Virtualization Procedure may be utilized to facilitate coordination of projected content and movement of the movable display. According to specific embodiments, at least some portions of the Mechanical Display Virtualization Procedure 1900 may be implemented at one or more devices/components of a gaming machine and/or at other devices/systems of the casino network.

For purposes of illustration, the Mechanical Display Virtualization Procedure of FIG. 19 will be described by way of example with reference to gaming machine 150 of FIG. 1B. In this example the Mechanical Display Virtualization Procedure may be implemented at gaming machine 150 which is operable to conduct wagering and/or game play activities involving display of a plurality of images. Conventionally, at least a portion of such images would be affixed to a mechanical wheel configured to rotate during game play and/or bonus play.

At 1902 it is assumed that at least one event has been detected for initiating a simulated display of a moving mechanical (or physical) object. In this particular example it is assumed that at least one event has been detected for initiating a simulated display of a moving wheel using the movable display device 145 of FIG. 1B. In at least one embodiment, a variety of different predetermined events and/or conditions may trigger activation of the moving virtual mechanical wheel of FIG. 1B.

At 1904, at least one operation may be initiated for determining and/or acquiring selected display content to be projected on to the movable display device. In at least one embodiment, at least a portion of the display content may be dynamically selected based on the event(s) which triggered activation of the moving virtual mechanical wheel. According to specific embodiments, at least a portion of the selected display content may be projected on to the movable display device (e.g., 145), and may include, for example: images, objects, graphics, text, symbols, etc. According to specific embodiments, at least some of the selected display content may be downloaded from a server to the gaming machine and/or retrieved from a local storage at the gaming machine.

At 1906, at least one operation may be initiated for determining current and/or expected motion/position data relating to the movable display device. According to specific embodiments, the motion/position data may include display motion data (e.g., described previously with respect to FIG. 2B) which, for example, may describe current (e.g., real-time), past and/or future motion-related characteristics of the movable display device. Examples of different types of motion-related characteristics may include, but are not limited to: directional vector data, velocity data, displacement data, orientation data, position data, acceleration data, deceleration data, etc.

At 1908, at least one operation may be initiated for determining selected display synchronization parameters for coordination of display content and display device movement. For example, in one embodiment, display synchronization parameters may be generated for causing the projected content to be rotated at a rate which substantially matches a current or real-time rotational velocity of the movable display device. Additionally, or alternatively, display synchronization parameters may be generated for causing the orientation of the projected content to be adjusted (e.g., in real-time) so that, when displayed, the orientation of the projected content is substantially aligned with the current rotational position/orientation of the display device, in accordance with specified alignment criteria.

As shown at 1910, projection display data may be generated. In at least one embodiment, the projection display data may be generated (e.g., in real-time, or in advance) using selected portions of the display synchronization parameters and display content. Further, in at least one embodiment, the projection display data may include content (e.g., images, objects, graphics, text, symbols, indicia, etc.) which has been specifically manipulated for projection on the movable display surface. For example, in a specific embodiment, the projection display data, which is to be projected onto the movable display surface, may include content which has been specifically manipulated to resemble a rotating mechanical wheel such as, for example, the mechanical bonus wheel of the well known Wheel of Fortune™ gaming machine. In some embodiments, the projection display data may also include timing data relating to various timing parameters which may be used, for example, to synchronize projection of the projected content with the movement of the movable display device.

As shown at 1912, desired content may be projected onto the surface of the movable display device using at least a portion of the projection display data.

In at least some embodiments, where at multiple projection devices are concurrently used to project different content on to one or more movable display devices, multiple instances of the Mechanical Display Virtualization Procedure may be initiated and executed concurrently.

FIG. 20 shows a flow diagram of a Bonus Game Virtual Mechanical Display Procedure 2000 in accordance with a specific embodiment. It will be appreciated that the Bonus Game Virtual Mechanical Display Procedure 2000 of FIG. 20 is intended to provide an example of a specific embodiment illustrating how the virtual movable mechanical display techniques of the present invention may be applied to bonus game activities conducted at a gaming machine.

For purposes of illustration, the Bonus Game Virtual Mechanical Display Procedure 2000 will be described by way of example with reference to gaming machine 150 of FIG. 1B.

As shown at 2002, it is assumed that at least one event and/or condition has been detected for initiating bonus game play activity at the gaming machine.

At 2004, at least one operation is performed for determining and/or acquiring bonus game display data relating to displayable content (e.g., images, objects, graphics, text, symbols, indicia, etc.) for playing a bonus game. In at least one embodiment, at least a portion of the displayable content may be dynamically selected based on the event(s) and/or conditions which triggered initiation of the bonus game activity. According to specific embodiments, at least some of the selected displayable content may be downloaded from a server to the gaming machine and/or retrieved from a local storage at the gaming machine.

At 2006 a current starting position of the bonus game display is determined. In one embodiment, the current starting position of the bonus game display may be automatically and dynamically selected based upon specified criteria. In other embodiments, the current starting position of the bonus game display has been predetermined based upon previous activities occurring at the gaming machine. For example, in one embodiment, the current starting position of the bonus game display may correspond to the ending or resting position of the bonus game display which occurred at the end of the most recent, previously played bonus game. In at least some embodiments (such as, for example, when specific content is continuously displayed or projected onto the movable bonus display device, even at times when no bonus game activity is occurring) the starting position of the bonus game display may correspond to the current relative position or orientation of the bonus game display, as can be observed by a player at the gaming machine.

As shown at 2008, when appropriate, the starting position bonus game image may be projected onto the movable bonus game display. It will be appreciated that this operation may be omitted in at least some embodiments such as, for example, where the starting position bonus game image is already being displayed at the movable bonus game display.

At 2010, an outcome for the bonus game is determined, received and/or obtained. According to specific embodiments, the outcome of the bonus game can, for example, be determined by the gaming machine and/or by a server machine. In one embodiment, a random number generator may be used to determine the bonus game outcome.

At 2012, at least one operation is performed to determine and/or acquire appropriate information for simulating movement(s) of content displayed on the bonus game display. As noted previously, examples of such movements may include rotational movements and/or linear movements. According to specific embodiments, at least a portion of such information can, for example, be determined by a server and/or the gaming machine. In one embodiment, the determined/acquired information may be based, at least partially, on a predetermined outcome of the bonus game. In one embodiment, such information may include and/or effectively represent one or more objects, text, symbols, etc to be displayed for the outcome.

As shown at 2014, the movable bonus game display may be physically moved while content is projected on the moving bonus game display. In specific embodiments where the bonus game display is intended to simulate the “look and feel” of a rotating mechanical bonus wheel, the movable bonus game display may be mechanically rotated while content is projected on the surface of the rotating display to provide the visual effect of mechanical wheel that is rotating. Thus, in at least some embodiments, the rotation of the bonus game display is coordinated with the projected images to give the appearance of a rotating mechanical wheel having static content imprinted thereon and/or affixed thereto.

At 2016, the movement (e.g., rotation) of the bonus game display is stopped, and the bonus game outcome is effectively displayed (e.g., projected) on the bonus game display. In at least some embodiments where the bonus game outcome has been predetermined, the movement (e.g., rotation) of the bonus game display and projected content may be coordinated such that the final resting position of the virtual mechanical bonus game display corresponds to the predetermined bonus game outcome. In at least one embodiment, after the bonus game outcome has been displayed, the player may be awarded with award such as, for example, credits, points, jackpot prize, etc.

Other System Embodiments

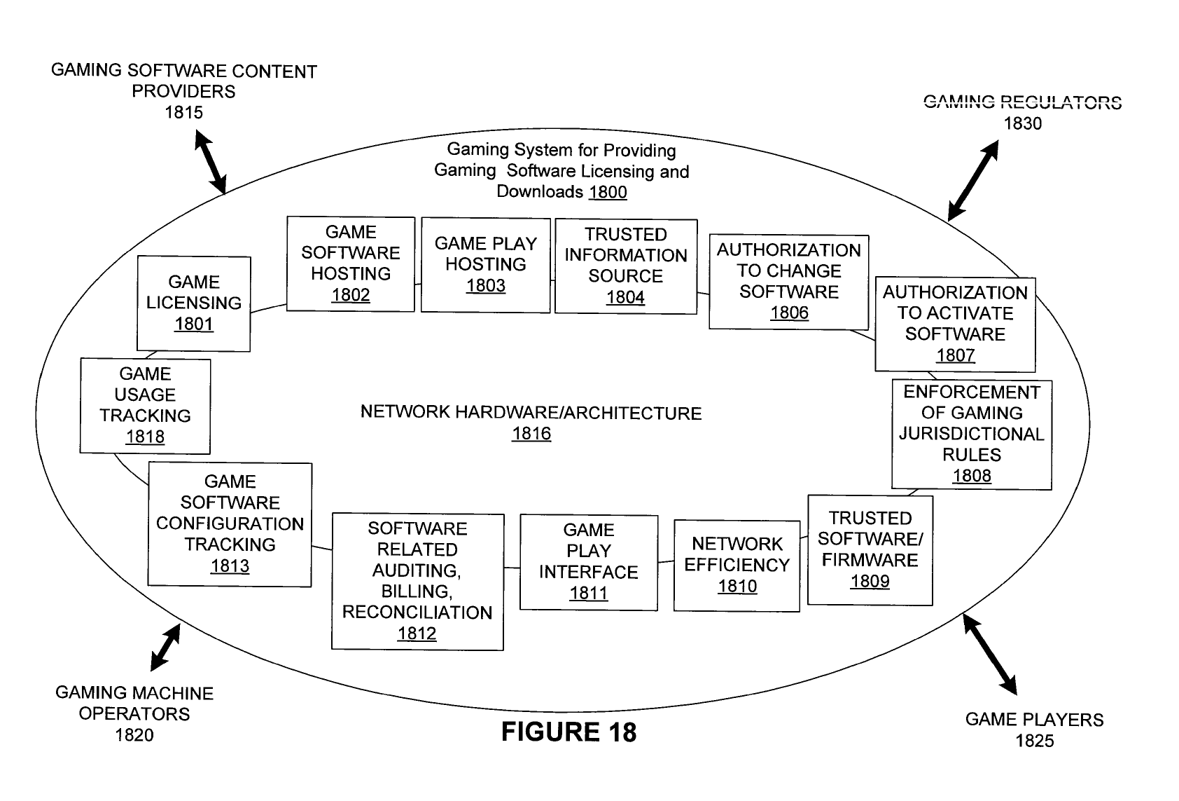

FIG. 18 shows a block diagram illustrating components of a gaming system 1800 which may be used for implementing various aspects of example embodiments. In FIG. 18, the components of a gaming system 1800 for providing game software licensing and downloads are described functionally. The described functions may be instantiated in hardware, firmware and/or software and executed on a suitable device. In the system 1800, there may be many instances of the same function, such as multiple game play interfaces 1811. Nevertheless, in FIG. 18, only one instance of each function is shown. The functions of the components may be combined. For example, a single device may comprise the game play interface 1811 and include trusted memory devices or sources 1809.

The gaming system 1800 may receive inputs from different groups/entities and output various services and or information to these groups/entities. For example, game players 1825 primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system 1800, receive revenue for the use of their software and compensate the gaming machine operators. The gaming regulators 1830 may provide rules and regulations that must be applied to the gaming system and may receive reports and other information confirming that rules are being obeyed.

In the following paragraphs, details of each component and some of the interactions between the components are described with respect to FIG. 18. The game software license host 1801 may be a server connected to a number of remote gaming devices that provides licensing services to the remote gaming devices. For example, in other embodiments, the license host 1801 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 1815 may track the usage of game software on a plurality of devices in communication with the host. The game usage-tracking host 1815 may be in communication with a plurality of game play hosts and gaming machines. From the game play hosts and gaming machines, the game usage tracking host 1815 may receive updates of an amount that each game available for play on the devices has been played and on amount that has been wagered per game. This information may be stored in a database and used for billing according to methods described in a utility based licensing agreement.

The game software host 1802 may provide game software downloads, such as downloads of game software or game firmware, to various devious in the game system 1800. For example, when the software to generate the game is not available on the game play interface 1811, the game software host 1802 may download software to generate a selected game of chance played on the game play interface. Further, the game software host 1802 may download new game content to a plurality of gaming machines via a request from a gaming machine operator.

In one embodiment, the game software host 1802 may also be a game software configuration-tracking host 1813. The function of the game software configuration-tracking host is to keep records of software configurations and/or hardware configurations for a plurality of devices in communication with the host (e.g., denominations, number of paylines, paytables, max/min bets). Details of a game software host and a game software configuration host that may be used with example embodiments are described in co-pending U.S. Pat. No. 6,645,077, by Rowe, entitled, “Gaming Terminal Data Repository and Information System,” filed Dec. 21, 2000, which is incorporated herein in its entirety and for all purposes.

A game play host device 1803 may be a host server connected to a plurality of remote clients that generates games of chance that are displayed on a plurality of remote game play interfaces 1811. For example, the game play host device 1803 may be a server that provides central determination for a bingo game play played on a plurality of connected game play interfaces 1811. As another example, the game play host device 1803 may generate games of chance, such as slot games or video card games, for display on a remote client. A game player using the remote client may be able to select from a number of games that are provided on the client by the host device 1803. The game play host device 1803 may receive game software management services, such as receiving downloads of new game software, from the game software host 1802 and may receive game software licensing services, such as the granting or renewing of software licenses for software executed on the device 1803, from the game license host 1801.

In particular embodiments, the game play interfaces or other gaming devices in the gaming system 1800 may be portable devices, such as electronic tokens, cell phones, smart cards, tablet PC's and PDA's. The portable devices may support wireless communications and thus, may be referred to as wireless mobile devices. The network hardware architecture 1816 may be enabled to support communications between wireless mobile devices and other gaming devices in gaming system. In one embodiment, the wireless mobile devices may be used to play games of chance.

The gaming system 1800 may use a number of trusted information sources. Trusted information sources 1804 may be devices, such as servers, that provide information used to authenticate/activate other pieces of information. CRC values used to authenticate software, license tokens used to allow the use of software or product activation codes used to activate to software are examples of trusted information that might be provided from a trusted information source 1804. Trusted information sources may be a memory device, such as an EPROM, that includes trusted information used to authenticate other information. For example, a game play interface 1811 may store a private encryption key in a trusted memory device that is used in a private key-public key encryption scheme to authenticate information from another gaming device.

When a trusted information source 1804 is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 2003/0203756, by Jackson, filed on Apr. 25, 2002 and entitled, “Authentication in a Secure Computerized Gaming System, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 1800 of example embodiments may include devices 1806 that provide authorization to download software from a first device to a second device and devices 1807 that provide activation codes or information that allow downloaded software to be activated. The devices, 1806 and 1807, may be remote servers and may also be trusted information sources. One example of a method of providing product activation codes that may be used with example embodiments is describes in previously incorporated U.S. Pat. No. 6,264,561.

A device 1806 that monitors a plurality of gaming devices to determine adherence of the devices to gaming jurisdictional rules 1808 may be included in the system 1800. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum bet limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 1800 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In example embodiments, the devices may be connected by a network 1816 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in example embodiments, network efficient devices 1810 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 1812. For example, a software licensing billing server may generate a bill for a gaming device operator based upon a usage of games over a time period on the gaming devices owned by the operator. In another example, a software auditing server may provide reports on game software downloads to various gaming devices in the gaming system 1800 and current configurations of the game software on these gaming devices.

At particular time intervals, the software auditing server 1812 may also request software configurations from a number of gaming devices in the gaming system. The server may then reconcile the software configuration on each gaming device. In one embodiment, the software auditing server 1812 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 18. Many of the interactions are coupled. For example, methods used for game licensing may affect methods used for game downloading and vice versa. For the purposes of explanation, details of a few possible interactions between the components of the system 1800 relating to software licensing and software downloads have been described. The descriptions are selected to illustrate particular interactions in the game system 1800. These descriptions are provided for the purposes of explanation only and are not intended to limit the scope of example embodiments described herein.

Techniques and mechanisms of embodiments described herein may sometimes be described in singular form for clarity. However, it should be noted that particular embodiments include multiple iterations of a technique or multiple instantiations of a mechanism unless noted otherwise.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

It is claimed:

1. A casino gaming machine comprising:
at least one processor;
at least one interface operable to provide a communication link to at least one other device;
memory;
a movable display device including a first surface portion; and
a projection system operable to project content onto the first surface portion of the movable display device;
the gaming machine being operable to project content onto the first surface portion of the movable display device during a first time period when the movable display device is moving;
the gaming machine being further operable to manage content projected onto the first surface portion of the movable display device such that the projected content is coordinated with movement of the movable display device during the first time period.

2. The gaming machine of claim 1 further comprising:
a content generation engine operable to dynamically generate at least a portion of the content projected by the projection system onto the first surface portion of the movable display device.

3. The gaming machine of claim 1 being operable to:
rotate the movable display device; and
coordinate content projected onto the first surface portion of the movable display device with the rotation of the movable display device in a manner which creates a visual appearance of a rotating mechanical wheel.

4. The gaming machine of claim 1 being operable to:
rotate the movable display device; and
coordinate content projected onto the first surface portion of the movable display device with the rotation of the movable display device in a manner which creates a visual appearance of a rotating mechanical sphere.

5. The gaming machine of claim 1 further comprising:
a first sensor device operable for determining motion information relating to movement activity of the movable display device;
a display synchronization system operable to synchronize, using at least a portion of the motion information, a first portion of the projected content with the movement of the movable display device such that the first portion of projected content is continuously projected at a fixed relative location on the first surface portion while the movable display device is moving.

6. The gaming machine of claim 1 wherein the projected content includes a first symbol, the gaming machine being further operable to:
detect rotational movement of the movable display device during the first time period;
coordinate content projected onto the first surface portion of the movable display device with the rotation of the movable display device in a manner which creates a visual appearance of a rotating mechanical display device having the first symbol affixed thereto.

7. The gaming machine of claim 1 wherein the movable display device is comprised of a transparent material.

8. The gaming machine of claim 1:
wherein the movable display device includes a first side and a second side opposite the first side, the first surface portion being located on the first side of the movable display device; and
wherein the movable display device is comprised of a material which enables content projected on the first side of the movable display device to be displayed on the second side of the movable display device.

9. The gaming machine of claim 1 wherein the gaming machine is operable for conducting casino gaming activities, and wherein the movable display device is operable for use as a bonus wheel, the gaming machine being further operable to:
rotate the movable display device;
project bonus content onto the first surface portion of the movable display device, the bonus content including a first plurality of symbols; and
coordinate bonus content projected onto the first surface portion of the movable display device with the rotation of the movable display device in a manner which creates a visual appearance of a rotating mechanical bonus wheel having the first plurality of symbols affixed thereto.

10. The gaming machine of claim 1 being further operable to:
determine a first rotational velocity of the movable display device during the first time period; and
manipulate a first portion of content projected onto the first surface portion of the movable display device such that the first portion of projected content is rotated at a rate which is substantially equal to the first rotational velocity of the movable display.

11. The gaming machine of claim 1 being further operable to:
determine a relative orientation of the movable display device at a first time T; and
manipulate a first portion of content projected onto the first surface portion of the movable display device such that a relative orientation of first portion of projected content at first time T is substantially aligned with the relative orientation of the movable display device at first time T.

12. A method for displaying content on a movable display device, the method comprising:
identifying content to be projected onto a first surface portion of the movable display device;
determining movement characteristics associated with the movable display device during a first time period when the movable display device is moving;
coordinating a first portion of the content to be projected with movement of the movable display device in a manner such that, when the first portion of content is projected onto the movable display device, the projected content is coordinated with movement of the movable display device; and
projecting the first portion of content onto the first surface portion of the movable display device during the first time period.

13. The method of claim 12 further comprising:
dynamically generating at least a portion of the content projected by the projection system onto the first surface portion of the movable display device.

14. The method of claim 12 further comprising:
rotating the movable display device; and
coordinating content projected onto the first surface portion of the movable display device with the rotation of the movable display device in a manner which creates a visual appearance of a rotating mechanical wheel.

15. The method of claim 12 further comprising:
rotating the movable display device; and
coordinating content projected onto the first surface portion of the movable display device with the rotation of the movable display device in a manner which creates a visual appearance of a rotating mechanical sphere.

16. The method of claim 12 further comprising:
synchronizing, using at least a portion of the movement characteristics, the first portion of the projected content with the movement of the movable display device such that the first portion of projected content is continuously projected at a fixed relative location on the first surface portion while the movable display device is moving.

17. The method of claim 12 wherein the first portion of content includes a first symbol, the method further comprising:
detecting rotational movement of the movable display device during the first time period;
coordinating content projected onto the first surface portion of the movable display device with the rotation of the movable display device in a manner which creates a visual appearance of a rotating mechanical display device having the first symbol affixed thereto.

18. The method of claim 12 further comprising:
determining a first rotational velocity of the movable display device during the first time period; and
manipulating the first portion of content projected onto the first surface portion of the movable display device such that the first portion of projected content is rotated at a rate which is substantially equal to the first rotational velocity of the movable display.

19. The method of claim 12 further comprising:
determining a relative orientation of the movable display device at a first time T; and
manipulating the first portion of content projected onto the first surface portion of the movable display device such that a relative orientation of first portion of projected content at first time T is substantially aligned with the relative orientation of the movable display device at first time T.

20. A movable display system comprising:
at least one processor;
at least one interface operable to provide a communication link to at least one other device;
memory;
a movable display device including a first surface portion;
a projection system operable to project content onto a first surface portion of the movable display device;
a content generation engine operable to dynamically generate at least a portion of the content projected by the projection system onto the first surface portion of the movable display device;
the movable display system being operable to project content onto the first surface portion of the movable display device during a first time period when the movable display device is moving;
the movable display system being further operable to coordinate projection of content onto the first surface portion of the movable display device with movement of the movable display device during the first time period.

21. The movable display system of claim 20 being further operable to:
rotate the first movable display device;
project a first portion of content onto the first surface portion of the movable display device, the first portion of content including a first plurality of symbols; and
coordinate the first portion of content projected onto the first surface portion of the movable display device with the rotation of the movable display device in a manner which creates a visual appearance of a rotating mechanical display device having the first plurality of symbols affixed thereto.

22. A system for displaying content on a movable display device, the system comprising:
means for identifying content to be projected onto a first surface portion of the movable display device;
means for determining movement characteristics associated with the movable display device during a first time period when the movable display device is moving;
means for manipulating a first portion of the content to be projected in a manner which results in the first portion of content being coordinated with movement of the movable display device during the first time period; and
means for projecting the first portion of content onto the first surface portion of the movable display device during the first time period.

23. A movable display system comprising:
at least one processor;
at least one interface operable to provide a communication link to at least one other device;
memory;
a movable display device including a first surface portion;
a projection system operable to project content onto a first surface portion of the movable display device;
the movable display system being operable to:
identify content to be projected onto a first surface portion of the movable display device;
determine movement characteristics associated with the movable display device during a first time period when the movable display device is moving;
coordinate a first portion of the content to be projected with movement of the movable display device in a manner such that, when the first portion of content is projected onto the movable display device, the projected content is coordinated with movement of the movable display device; and
project the first portion of content onto the first surface portion of the movable display device during the first time period.

24. The movable display system of claim 23 being further operable to:
dynamically generate at least a portion of the content projected by the projection system onto the first surface portion of the movable display device.

25. The movable display system of claim 23 being further operable to:
rotate the movable display device; and
coordinate content projected onto the first surface portion of the movable display device with the rotation of the movable display device in a manner which creates a visual appearance of a rotating mechanical wheel.

26. The movable display system of claim 23 being further operable to:
rotate the movable display device; and
coordinate content projected onto the first surface portion of the movable display device with the rotation of the movable display device in a manner which creates a visual appearance of a rotating mechanical sphere.

27. The movable display system of claim 23 being further operable to:
synchronize, using at least a portion of the movement characteristics, the first portion of the projected content with the movement of the movable display device such that the first portion of projected content is continuously projected at a fixed relative location on the first surface portion while the movable display device is moving.

28. The movable display system of claim 23 wherein the first portion of content includes a first symbol, the movable display system being further operable to:
detect rotational movement of the movable display device during the first time period;
coordinate content projected onto the first surface portion of the movable display device with the rotation of the movable display device in a manner which creates a visual appearance of a rotating mechanical display device having the first symbol affixed thereto.

29. The movable display system of claim 23 being further operable to:
determine a first rotational velocity of the movable display device during the first time period; and
manipulate the first portion of content projected onto the first surface portion of the movable display device such that the first portion of projected content is rotated at a rate which is substantially equal to the first rotational velocity of the movable display.

30. The movable display system of claim 23 being further operable to:
determine a relative orientation of the movable display device at a first time T; and
manipulate the first portion of content projected onto the first surface portion of the movable display device such that a relative orientation of first portion of projected content at first time T is substantially aligned with the relative orientation of the movable display device at first time T.
